(19) United States
(12) Patent Application Publication
(10) Pub. No.: US 2014/0186806 A1
(43) Pub. Date: Jul. 3, 2014

(54) PUPILLOMETRIC ASSESSMENT OF LANGUAGE COMPREHENSION

(71) Applicants: Brooke Hallowell, Millfield, OH (US); Laura Roche Chapman, Athens, OH (US)

(72) Inventors: Brooke Hallowell, Millfield, OH (US); Laura Roche Chapman, Athens, OH (US)

(73) Assignee: OHIO UNIVERSITY, Athens, OH (US)

(21) Appl. No.: 14/237,614

(22) PCT Filed: Aug. 9, 2012
(86) PCT No.: PCT/US12/50139

§ 371 Date: Feb. 7, 2014

Related U.S. Application Data
(60) Provisional application No. 61/521,405, filed on Aug. 9, 2011.

(51) Int. Cl. G09B 19/04

(52) U.S. Cl. CPC G09B 19/04
USPC 434/167

(57) ABSTRACT

The present invention is a method for assessing a patient's linguistic comprehension using a pupil response system comprising at least one pupillometer configured to measure the patient's pupil responses. The method includes (a) providing the patient with a list of verbal stimuli comprising at least two sets of verbal stimuli, each set of verbal stimuli comprising one or more verbal stimuli; wherein the two sets of the verbal stimuli differ substantially from each other in terms of the difficulty level; (b) presenting to the patient one verbal stimulus at a time from the list of verbal stimuli; (c) measuring and recording the patient's pupil response data for a period of time ranging from 200 milliseconds to 10 seconds during the presentation of each stimulus; and (d) analyzing the pupil response data to assess the patient's linguistic comprehension.

### BACKGROUND OF THE INVENTION

This application claims the benefit of U.S. Provisional Application No. 61/521,405 filed on Aug. 9, 2011, which is incorporated herein by reference.

This invention relates generally to the field of cognitive and linguistic assessment methods and relates more particularly to methods for assessing cognitive and linguistic abilities by measuring the pupil sizes of a patient in response to predetermined verbal and/or visual stimuli.

### DESCRIPTION OF THE RELATED ART

Cognitive and linguistic abilities in individuals can be assessed and studied using a variety of well-known constructs, such as thorough testing of linguistic comprehension, semantic associative priming, working memory, and attention. However, traditional clinical and research measures associated with such constructs are fraught with methodological limitations and “confounds,” thus reducing the validity and generalization of findings, especially with regard to people with neurological impairments or disorders. “Confounds” are factors that threaten assessment validity. These confounds include comprehension of instructions, memory, motor abilities required for responding, as well as problems of using off-line (summative) measures (those gathered after a task has been completed) as opposed to online measures (those occurring while a person is engaged in a task). These confounds might create inconsistent and/or inaccurate assessment of linguistic comprehension in an individual, especially for individuals with neurological impairments. Neurologically impaired people might or might not have any linguistic comprehension deficits, resulting in disorders such as aphasia.

Furthermore, traditional methods often require the use of multiple linguistic skills, hindering the accurate assessment of any single cognitive ability in an individual, such as linguistic comprehension (also called language comprehension). For example, the most commonly used assessment method, Story Retell Task method, uses both short-term memory skills and linguistic comprehension skills. In this method, patients are told a story and asked to retell it. If the patients are able to retell the basic elements of the story, they demonstrate that they understood the story. With regard to the assessment of linguistic comprehension of the patients, this method has an inherent confound of relying on short-term memory skills that may or may not interfere with actual linguistic comprehension. Even if the memory skills do not interfere with actual linguistic comprehension, it would be hard to separate the assessment of linguistic comprehension from the short-memory skills. In addition, this retelling method relies on patients' speech or writing abilities in retelling stories verbally or textually (writing). To accurately assess comprehension, one must rule out the possible response failures or inconsistencies in memory, speech writing, gesture, and other motor activities among individuals, especially for individuals with neurological impairments.

The assessment of comprehension in individuals with stroke and brain injury is even more difficult. It is well known that there are many confounds in the assessment of such individuals. Concurrent with impairments of language, these individuals more often than not have impairments of attention, vision, and motor function, contributing to the existence of many confounds. It is difficult to assure the validity of a language assessment when these individuals have many associated impairments. For example, it is difficult to determine whether an incorrect answer or a lack of response during clinical assessment is caused by language comprehension deficiencies and not by other defects, such as the inability to respond.

Hallowell (1999, 2002) discloses an eye-tracking method that involves measuring and tracking individuals' eye fixations in response to visually and/or auditorally presented stimuli. Despite numerous advantages of using eye-tracking to capture indices of comprehension, the disadvantage of this method is that individuals can control where they fixate their eyes as they look at various components of a visual display. In other words, even if an individual is told to look naturally and not control his or her eyes in any particular way, he or she may still try to control where he or she looks so as to respond in a more correct or desirable way. As a result, the intended purpose of using spontaneous, unplanned movements of the eyes may be spoiled in cases where viewers attempt to control their fixation patterns. Further, in some cases, individuals with ocular motor apraxia have difficulty looking intentionally at images during fixation-based comprehension tasks, further complicating eye fixation-based assessments.

Pupillometry has been used to test cognitive intensity through the measurement of pupil dilation and constriction, including the technique of task-evoked responses of the pupil (TERPs). Most of these prior studies used people without aphasia to study potential correlations between pupillary responses and cognitive efforts. Although these findings confirm that pupillometric measures are sensitive to processing load, they cannot be used to provide a clinical assessment method to index a person's true ability to understand language.

Firstly, the previous studies used non-clinically relevant stimuli, such as mental mathematical problems, memory load for words and digits, pitch discrimination, mental arithmetic, letter discrimination, speech shadowing/sentence repetition, sentence comprehension, cross-linguistic interpretation, and forced-choice tasks. These non-clinically relevant stimuli cannot provide any clinically useful information about a patient's actual linguistic comprehension level in order to evaluate whether this individual has any linguistic comprehension deficit, especially if the individual has any neurological impairment.

Clinical assessment methods should produce useful information about a person's true ability to understand everyday language (indexing language comprehension level in a clinically relevant way). Useful information should be information related to how a person normally uses language. As a practical matter, knowing how much a person understands when listening to others speak is essential for appropriate treatment, socialization, and major life decisions related to living arrangements, financial management, legal status, and potential for return to work, educational, and leisure activities. Clinically relevant stimuli are those stimuli related to an individual's everyday functional use of the language that leads to useful information regarding an individual's linguistic comprehension level. Non-clinically relevant stimuli are language stimuli related to unusual use of language that will not lead to useful information about a person's language abilities. For example, whether the subject and object of the sentence would fit thematically with the verb is an unusual use of language, which is not relevant to a person's everyday functional language comprehension ability. In addition, incorrect responses or failure to respond to these non-clinically relevant stimuli do not necessarily indicate a failure to comprehend.

More importantly, the prior studies have not used varied difficulty levels of verbal stimuli to index language cognitive effort in a clinically relevant way for people with neurological disorders. More specifically, these studies did not evaluate the sensitivities and/or consistency of pupillary methods to study cognitive efforts as related to differing difficulty levels of a variety of words and sentence types. Indexing cognitive efforts as related to varying difficulty levels of words and sentences used in everyday functional language can offer a clinically relevant way to detect any possible linguistic deficits in a person with neurological disorders.

Further, the above studies have all used people without any linguistic impairment, such as aphasia. Until recently, pupillometric research has not been applied to individuals with aphasia. People with aphasia have many confounds concurrent to the linguistic comprehension deficits, including the impairments of vision. In addition, pupil dilations inherently can be influenced by many factors other than cognitive efforts, such as light, emotional, and physical stimuli. The task-evoked pupillary responses as related to processing loads are relatively slight in comparison to the pupillary responses induced by other factors, and thus can be easily masked by other confounding factors.

Jackson and Lucero-Wagoner (2000) state in their book “Pupillary System” that a task-evoked pupillary response is the tendency of a pupil to dilate slightly in response to loads on working memory increased attention, sensory discrimination, or other cognitive loads. The pupil dilates more significantly in response to extreme emotional stimulations such as fear, or to contact of a sensory nerve, such as pain.

Gutierrez and Shapiro (2011) used pupillometry to examine the different effects of relative thematic fit between a verb and its arguments between people with aphasia (PWA) and similarly aged people without aphasia (aged-matched controls). In Gutierrez and Shapiro's study, participants listened to sentences in which the subject and object of the sentence either fit thematically with the verb (plausible sentences) or did not fit thematically with the verb (implausible sentences). In both groups of participants with and without aphasia, implausible sentences elicited greater pupillary dilations than plausible sentences.

However, as discussed before, Gutierrez and Shapiro's method used non-clinically relevant stimuli—the thematic fit of a verb in a sentence, and these non-clinically relevant stimuli would not provide any clinically useful information about an individual's actual linguistic comprehension level. Also, no correlations were drawn between pupillometric data and data from the current standardized clinical language comprehension tests. As such, their method does not offer insight on how to use pupillometry to index an individual's actual linguistic ability in a clinically relevant way in order to detect any potential linguistic deficit, especially if the individual has a neurological impairment.

More importantly, Gutierrez and Shapiro's results show that participants without aphasia actually took longer to respond than people with aphasia, which is contrary to a well-known fact that people with aphasia typically take longer to comprehend linguistic information. Therefore, the results suggest that pupillometry would not be able to detect the differences between the pupillary responses of people with aphasia and those of people without aphasia as related to cognitive effort or difficulty of comprehension tasks. Further, the study teaches that pupillometry might not be a valid method to use for indexing the linguistic comprehension levels of an individual so as to detect any linguistic deficit.

### BRIEF SUMMARY OF THE INVENTION

There is a great need for more valid and reliable methods of assessing comprehension in individuals with or without neurological disorders, due to numerous potential confounds in many commonly used methods of assessment. A greater need exists for assessing individuals with neurological disorders to evaluate whether they have any linguistic impairments and/or the level of linguistic impairment. Therefore, an effective, consistent and sensitive pupillometric method for clinical assessment of linguistic comprehension for individuals, especially individuals with aphasia or other neurological disorders, is greatly desired, particularly for assessment of any possible or potential linguistic impairment and/or the level of the impairment.

There are several advantages of using the present invention over traditional clinical methods. Linguistic comprehension deficits in many patients may be overestimated or underestimated according to experimental data, test results and clinical judgment based on existing methods. Using the method of the present invention, the person being assessed does not need to understand any instructions. The device can be in contact with the person being assessed, such as by using a pupilometer (sometimes referred to as “pupillometer”) mounted on the head. Alternatively and/or preferably, a remote device can be used to measure, record and analyze the pupillary response, and the device will not be in contact with the person (although, sometimes, a chin rest may be used to help keep the head relatively stable).

In addition, the methods allow for: stimulus adaptations that may serve to control for perceptual, attentional, and ocular motor deficits in the differential diagnosis of language processing difficulties; reduced reliance on patients' understanding and memory of verbal instructions prior to testing; allowance for a real-time measure of comprehension; and allowance for testing of a broad range of verbal and nonverbal stimulus types. An additional advantage of the present invention is that pupillary control is often preserved even in cases of severe motoric and cognitive deficits, therefore the present invention has the sensitivity and consistency to assess the individual's linguistic comprehension to yield clinically useful data as to the level of the linguistic comprehension, if any impairment exists, and the level of linguistic impairments.

Advantages of pupillometry over eye fixation analysis alone include that viewers are not able to consciously control their own pupil size. Given that pupil size is controlled subcortically and automatically through the reticular activating system in the brainstem, confounds associated with intentional conscious control of the eyes that may occur when monitoring fixations are not possible when using pupillometry.

Broadly, the present invention provides methods for assessing a patient's linguistic comprehension using a pupillary response system (also called “pupillary system”), especially for patients with neurological disorders or impairments. The pupillary system includes at least one pupillometer configured to measure the patient's pupil response to index linguistic comprehension according to the varied difficulty levels of the verbal stimuli. For purposes of the present invention, a pupillometer is defined as any instrument for measuring the width and/or the diameter of the pupil.

A first of the inventive methods is directed toward the assessment of linguistic comprehension using verbal stimuli. In accordance with the method, a list of verbal stimuli is first selected, which is separated into at least two sets of stimuli. Each set of stimuli includes one or more verbal stimuli in the list; the two sets of the verbal stimuli differ substantially from each other in terms of the difficulty level. The verbal stimulus for the present inventive method preferably includes one or more words, one or more sentences, or combinations or mixtures thereof. In some preferred embodiments, the verbal stimulus includes one or more words, with a single noun being the most preferred. The difficulty level of the word is based on one or more difficulty criteria, including, but not limited to, age of acquisition, word frequency, familiarity, naming latency, other similar factors, or combinations thereof. Other similar factors can include the length of the word, different pronunciation of the word, and perceived difficulty level.

The perceived difficulty of the verbal stimuli can be evaluated by asking the patient to sort the verbal stimuli into two different levels: one is relatively easy, while the other is relatively difficult. It is contemplated that other methods of evaluating the difficulty levels can also be used so long as these methods provide relatively reliable information about the perceived difficulty of the verbal stimuli.

Next, a clinician presents the patient with one verbal stimulus at a time from the list of verbal stimuli (the assessment task), and then the patient's pupillary response data during the presentation of each stimulus are measured and recorded for a period of time ranging from about 200 milliseconds to about 10 seconds. Preferably, the clinician instructs the patient to look at a fixation point during the presentation of each verbal stimulus. Further, to keep the patient focused on the assessment task, a clinician preferably administers to the patient one or more comprehension tests during the presentation of the verbal stimuli.

At the end of the task, the pupillary response data for all stimuli are analyzed and interpreted to assess the patient's linguistic comprehension in terms of the difficulty levels of the stimuli. The patient's pupillary response data can then be compared to the normative data, the normative data being pupillary response data of known healthy individuals to the same verbal stimuli. If the patient's pupillary response data are significantly different from the normative data, then this is a good indicator that the patient has a linguistic comprehension deficit.

The method is capable of assessing the linguistic comprehension level of neurologically impaired patients. The impairment severity of the patient is preferably evaluated prior to the starting of the assessment tasks, such as presenting the stimuli to the patient.

In some preferred embodiments, a baseline test is preferably administered to the patient, and the patient's pupillary response data during the baseline test is measured and recorded (called the baseline measures or values). The baseline measures can then be incorporated into the analysis of the pupillary response data for the assessment task to eliminate the impact of emotional factors on the pupillary response.

Preferably, the verbal stimuli are presented to the patient audibly to assess the patient's auditory comprehension level. At the same time, auditory presentation can avoid many distracting factors associated with textual presentation (also visual presentation) to give a more accurate analysis of the pupillary response as related to linguistic cognitive efforts associated with varying difficulty levels of verbal stimuli. Alternatively, the verbal stimuli are presented to the patient textually to assess the patient's reading comprehension level.

In some other preferred embodiments, the verbal stimulus includes one or more sentences, with a single sentence being the most preferred. The difficulty level of the sentence is determined according to one or more criteria. The suitable criteria include, but are not limited to, sentence length, sentence branches, number of verbs, number of imbedded clauses, other similar factors, or combinations or mixtures thereof.

In the present inventive method, the pupillary responses (also called pupillary response data or pupillary response measures) include pupil diameter, maximum pupil diameter, time to maximum pupil diameter, average pupil diameter, and/or other similar data.

A second of the inventive methods is directed toward the assessment of linguistic comprehension using the combination of visual and verbal stimuli. In accordance with the method, a list of verbal stimuli is first selected, which comprises at least two sets of verbal stimuli of substantially different difficulty levels. The visual stimuli are then selected, in which each visual stimulus includes an image that corresponds to the verbal stimulus in the verbal stimuli list. Further, the visual stimuli are preferably designed to minimize the presence of distracting visual features.

Next, a clinician presents each pair of visual and verbal stimuli to the patient in the following manner: a visual stimulus is presented to the patient at the same time as or immediately after presenting each verbal stimulus, the visual stimulus comprising at least one image that corresponds to the verbal stimulus being presented at the same time or immediately prior to the said visual stimulus. The visual stimulus is preferably presented on a computer monitor screen.

The pupillary responses of the patient are measured and recorded during the presentation of each stimulus. After the completion of the assessment task (all stimuli are presented to the patient), the pupillary response data are analyzed and interpreted to assess the patient's linguistic comprehension illustrated in the first of the inventive methods.

To keep the patient's focus on the assessment process, one or more foil trials are at times preferably administered to the patient. The foil trial includes the steps of presenting the patient with a foil stimulus at the same time as or immediately after presenting a verbal stimulus as illustrated in FIG. 9 (steps 94 to 95) and 11 (steps 114 to 115). The foil trial comprises one or more images that do not correspond to the verbal stimulus being presented at the same time or immediately prior to the foil stimulus. The foil trial can be repeated at one or more intervals as needed. The method may comprise about 10% to 30% of foil trials.

In addition, the clinician may preferably present one or more filler stimuli to the patient to substantially reduce or prevent the pupillary changes in the patient due to any potential abrupt change in luminance between the stimuli.

The methods in the present invention preferably use pupillary response systems that are suitable for purposes of the present invention. The pupillary response system preferably includes a near infrared light and processing software, and more preferably with a video camera. The processing software is capable of identifying, measuring, recording, and analyzing the patient's pupillary response data, such as pupil center, pupil diameter, maximum pupil diameter, average pupil diameter, latency time to maximum pupil diameter, and/or other similar data.

In some preferred embodiments of the first and second inventive methods, the clinician preferably administers hearing and/or vision screenings to the patient prior to presenting the patient with any stimuli (see FIG. 2).

### BRIEF DESCRIPTION OF THE SEVERAL VIEWS OF THE DRAWINGS

FIG. 1a is a flowchart illustrating a broad embodiment of the method of the present invention for using verbal stimuli to assess linguistic comprehension.

FIG. 1 is a flowchart illustrating a more preferred embodiment of the method of FIG. 1a.

FIG. 2 is a perspective view illustrating a patient seated in front of a computer monitor during testing using the pupillary methods of the present invention.

FIG. 3 is a flowchart illustrating a more preferred embodiment of the method of FIG. 1a, in which a baseline test is administered.

FIG. 4 is a flowchart illustrating a broad embodiment of the method of the present invention for using visual and verbal stimuli to assess linguistic comprehension.

FIG. 5 is an illustration of a sample visual stimulus used in the method for testing linguistic comprehension of the present invention. This image is presented simultaneously with a corresponding word.

FIG. 6 is an illustration of a sample foil visual stimulus used in the method for testing linguistic comprehension of the present invention. This image was presented simultaneously with a non-corresponding word as specified in the foil stimulus protocol.

FIG. 7 is an illustration of a sample image of a filler stimulus used in the method for testing linguistic comprehension of the present invention. This filler stimulus image was displayed for about three seconds between each experimental stimulus item.

FIG. 8 is a flowchart illustrating a portion of a preferred embodiment of the method of FIG. 1a, in which the comprehension test is administered to keep the patient focus on the assessment test.

FIG. 9 is a flow chart illustrating a portion of a preferred embodiment of the preferred embodiment of the method of FIG. 4, in which a foil stimulus test is administered.

FIG. 10 is a flow chart illustrating a portion of a preferred embodiment of the preferred embodiment of the method of FIG. 4, in which a filler stimulus is administered.

FIG. 11 is a flow chart illustrating a portion of a preferred embodiment of the preferred embodiment of the method of FIG. 4, in which both foil stimulus test and filler stimulus are administered.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

Broadly, the present invention is a method for assessing a patient's linguistic comprehension using a pupillary response system (also called “pupillary system”), especially for patients with neurological disorders or impairments. The pupillary system includes at least one pupilometer configured to measure the patient's pupil response to index linguistic comprehension according to the varied difficulty levels of the verbal stimuli. For purposes of the present invention, pupilometer (also called “pupillometer”) is defined as any instrument for measuring the width and/or the diameter of the pupil. Pupilometers may comprise hand-held units, head-mounted units, units with a chin rest, remote units, other similar units, or combinations thereof so long as they are suitable for the purposes of the present invention. In the present application, the individual to be assessed of his or her linguistic comprehension skill or level can be referred to as “patient” or “participant.” The person executing the assessment method on a patient is referred to as “researcher” or “clinician.” The suitable verbal stimuli are words or sentences of varying difficulty levels as discussed in detail below.

### Verbal Stimuli Only Method

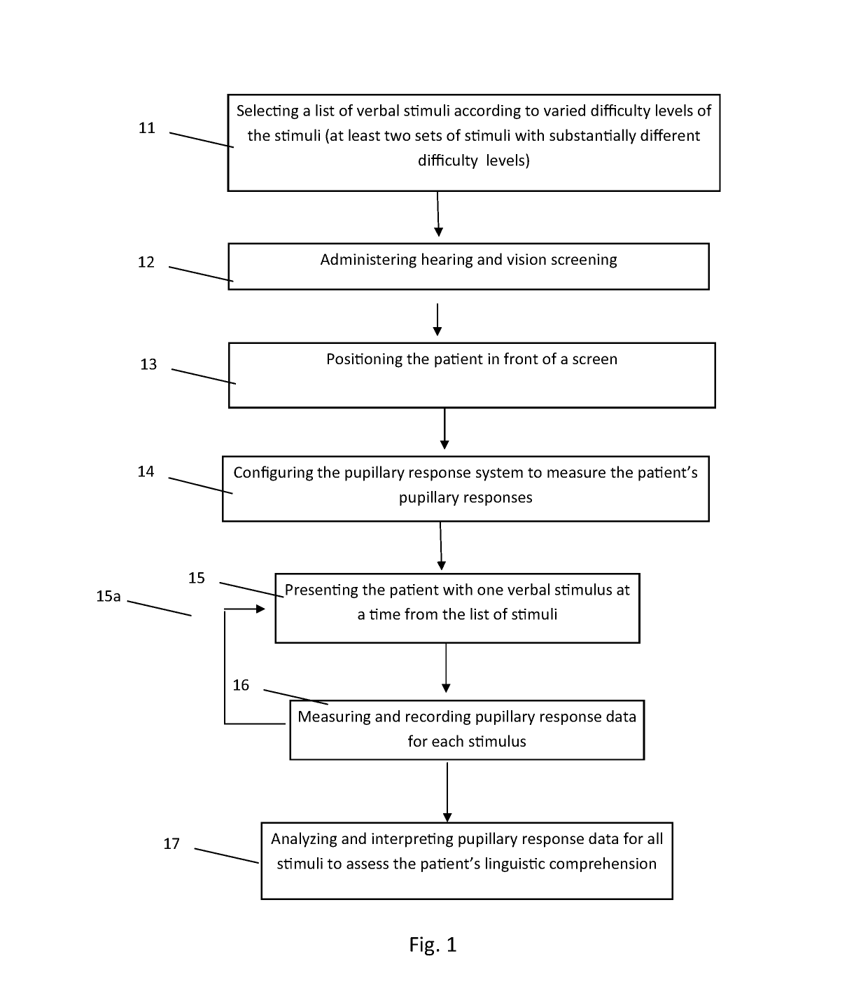

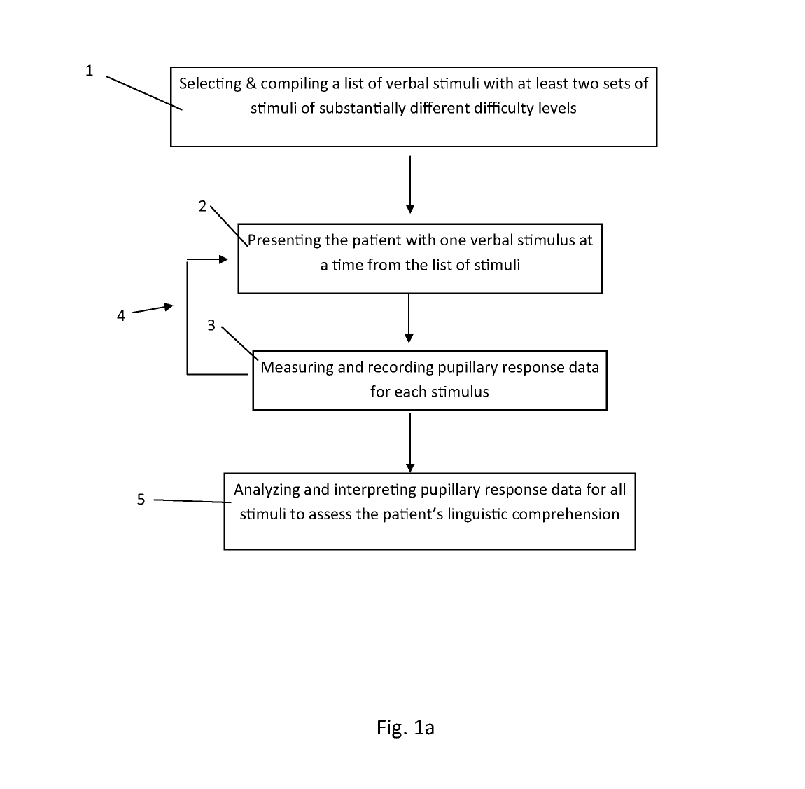

According to FIG. 1a, a broad embodiment of the present invention is a method including the steps of (1) selecting or compiling a list of verbal stimuli with at least two sets of verbal stimuli of substantially different difficulty levels; (2) presenting to the patient one stimulus at a time from the list of stimuli in a random order or a set order; (3) measuring and recording the patient's pupil response data; (4) repeating steps 2 and 3 until all stimuli from the list are presented to the patient; and then (5) analyzing and interpreting the pupil response data for all stimuli to assess the patient's linguistic comprehension. The pupil response data are preferably compared to the data collected for people without any neurological disorder, and the differences in the response can indicate whether or not the patient has any linguistic impairment and/or the degree of the impairment.

While not wishing to be bound by theory, it is presently believed that participants with linguistic comprehension impairments (often due to aphasia) would exhibit significantly different patterns of pupillary responses than participants without any impaired language abilities, and that these differences could be measured and used as indicators of impaired comprehension. Therefore, the method can also be used to index linguistic comprehension in participants with and/or without neurological disorders or impairments.

A preferred inventive method of the present invention is illustrated by FIG. 1. In this method, after the list of verbal stimuli is selected and compiled 11, hearing and vision screenings are administered to the patient 12. The selected patient is then positioned in front of a screen 13 followed by configuring the pupillary response system to measure the patient's pupillary response 14. Alternatively, the configuration of the pupillary response system 14 can be done prior to the step 13 of positioning the patient. The list of stimuli from step 11 is then presented to the patient one stimulus at a time 15, during which the pupillary response data are measured and recorded for each verbal stimulus 16. Steps 15 and 16 are repeated 15a until all suitable stimuli in the list are presented to the patient, and then the pupillary response data are analyzed and interpreted 17 for all verbal stimuli to assess the patient's linguistic comprehension level.

Referring to the first step 11 of the inventive method in FIG. 1, a suitable list of verbal stimuli is selected according to the varied stimuli levels of the verbal stimuli. Preferably, the verbal stimuli have at least two sets of verbal stimuli, in which the two sets of the verbal stimuli differ substantially from each other in terms of the difficulty level. Each set of the verbal stimuli has one or more verbal stimuli. Significantly differing levels of difficulty in the verbal stimuli can result in different cognitive efforts exerted by the patient, which translate into different pupillary responses in terms of comparative changes in the pupillary diameters. These pupillary responses are measured and recorded by the pupil response measurement system, and analyzed to assess the patient's linguistic comprehension. The present method is sensitive enough to test even slight differences in pupillary responses with regard to the cognitive efforts exerted for different difficulty levels of verbal stimuli. Thus, the present method is capable of assessing a person's linguistic comprehension level to see if that patient has any linguistic comprehension deficit, substantially reducing confounds associated with the traditional assessment method.

More than two sets of verbal stimuli can be used so long as the difficulty levels between the sets of stimuli are substantial and/or significant, ensuring that substantially different cognitive efforts are being exerted on each set of stimuli, resulting in substantially different pupillary response in a patient. Preferably, the two sets of verbal stimuli are used with one set of verbal stimuli being substantially relatively difficult stimuli, and the other set of verbal stimuli being substantially relatively easy. The suitable verbal stimuli include words or sentences of varying difficulty levels (see details of stimuli selection in the section of STIMULI SELECTION). According to one embodiment of the inventive method, the verbal stimulus is one or more words. Preferably, the verbal stimulus is one word, in which case the method includes two sets of words and/or sentences, one set of words and/or sentences are substantially more difficult than average, while the other set of words and/or sentences are substantially easier than average words. The patient's responses to the two sets of words, such as the responsive changes of his or her average pupil diameter, can then be compared to that of the average pupil responses from individuals without any neurological disorder to evaluate whether or not the patient has any linguistic impairment, and even to determine the extent of the patient's linguistic comprehension impairments. The criteria and/or methods of selecting and compiling the verbal stimuli are discussed in detail hereinbelow.

Next, a patient to be tested is preferably required to pass a vision and/or a hearing screening 12 as shown in FIG. 1. Other screenings can also be administered, such as pupillary response, to ensure that the patient is a suitable individual for using the present inventive method. The vision screening is optionally or preferably administered to demonstrate the patient's vision acuity is appropriate for reading text or visual image on a computer screen or monitor at a suitable distance (preferably about 20-30 inches), with the exact distance dependent upon the size of visual stimuli and the type of screen on which the visual stimuli will be presented to the patient during assessment tasks, as is described in detail below. Glasses or contact lenses can be used if necessary for corrected vision. The patient is preferably or optionally also required to pass a hearing screening to demonstrate appropriate hearing acuity for 500-, 1000-, and 2000-Hz pure tones at 65 dB or 25 dB, or other suitable levels. If the patient fails to pass the visual and/or hearing screenings, he or she is preferably excluded from further testing, or the procedure is modified to accommodate the disability.

It is contemplated that other suitable and/or similar methods for screening the vision and hearing of the patient, as well as methods for testing other physical and/or neurological conditions of the patient, can additionally or alternatively be administered. For example, additional screening methods may include a standard central visual acuity screening, a color vision screening, a peripheral visual acuity screening, a screening for intactness of the patient's retina, a pupillary examination, ocular motility testing, and an examination of the patient's eyes for swelling, redness, drainage and lesions that may interfere with eye tracking (described below). In some cases, the information from the screening methods is not used to exclude a patient from the testing; instead the information is used to document any deviance from the normal in order to examine for possible effects on the pupillary response data from the testing.

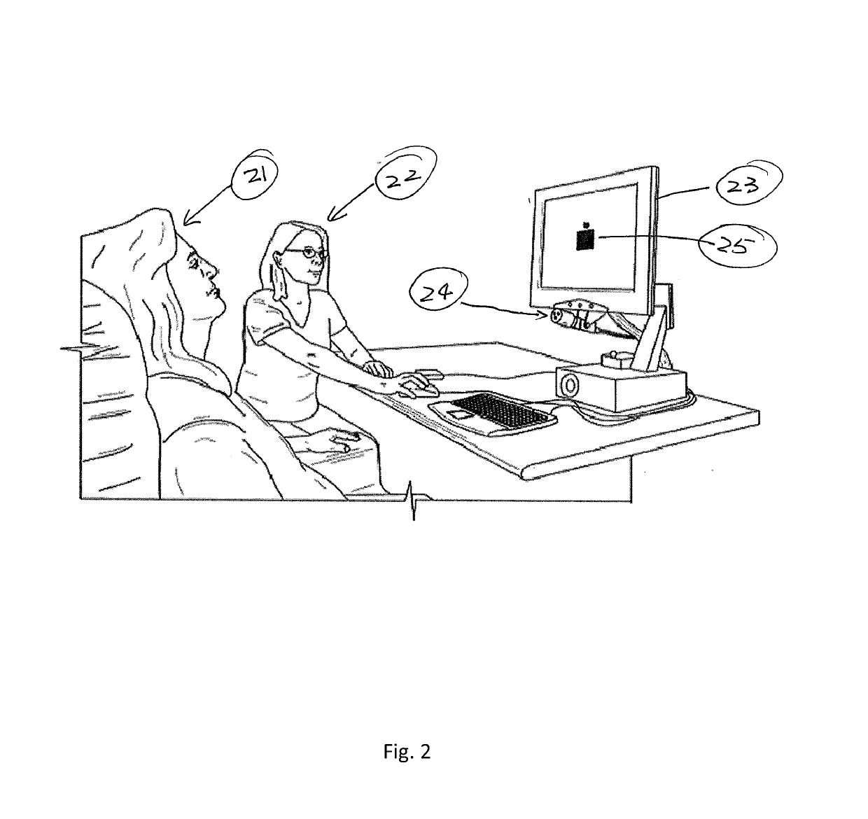

Referring again to FIG. 1, the next step 13 (FIG. 1) of the inventive method is positioning the patient in front of a screen as shown in FIG. 2. A suitable pupillary response system is then configured 14 to measure the patient's pupillary responses. In a more preferred embodiment of the present inventive method according FIG. 2, the patient 21 is positioned in front of a conventional computer monitor 23 in a comfortable, seated position. The screen can be a board, a piece of paper, or a computer screen or monitor, or other suitable surfaces on which the text of the verbal stimuli and/or the visual stimuli can be presented to the patient for purposes of the inventive method. The suitable pupillary response system should include at least one suitable pupilometer to measure the patient's pupil response. The key feature of the pupilometer is that it should be capable of measuring the patient's pupil response (pupil diameter etc.) frequently without unduly distracting the patient.

In the present invention, the pupillary measurements are preferably obtained in an unobtrusive way so as to avoid adding any non-cognitive related stimulation to the participants. Further, the pupilometer should be positioned so as to provide consistent measurements. Hand-held units might provide high precision (if correctly used) but it might be cumbersome to use and annoying to the patients and/or clinicians. Similarly, the head-mounted pupilometer or camera might provide higher precision but can be bothersome to the patients. In addition, care must be taken with head mounted pupilometer to keep the head band from slipping.

The head-mounted units, units with chin rests, or remote units are preferred choices, with the remote units being the most preferred. Among the remote units, the remote units that employ desktop or display-mounted camera are more preferred because they eliminate the need for distracting head-mounted cameras or chin rests.

A pupilometer may measure the pupil size in several different ways. One way is through a series of graduated filled circles whose sizes are compared with the pupil. The more preferred way is through the use of corneal reflection technology (also called corneal reflection photography or video photography). In using the corneal reflection technology, pupilometers are often combined with eye tracking techniques to ascertain the pupil diameter, the eye movement and the gaze direction.

Corneal reflection technology is a non-contact, optical method. The preferred pupilometer comprises one or more image capturing means, one or more illuminators, and image and/or data processing software. The image capturing means can be a camera, or a video camera, or other optical or image sensor. The illuminator can be a near infra-red light source, preferably near infra-red light emitting diodes (LED). Light from these illuminators, invisible to the human eye, creates reflection patterns on the cornea of the eyes. At high sampling rates, one or multiple images or optical sensors register the image of the patient's eyes. Then image processing software is used to find the eyes, detect the exact position of the pupil and/or iris, and identify the correct reflections from the illuminators and their exact positions. The equipment often must be calibrated prior to actual measurements in order to obtain certain actual physiological features of the eyes, such as the radius of the curvature of the eye's cornea and the angular offset between the eye's optic and focal axes.

In this method, the center of the pupil is not directly measurable from the image sensor, typically a camera (a regular camera or video camera). Typically, the pupil center is estimated by observing the edges of the pupil and calculating the center location from the edge measurements. Due to the fact that the pupil lies behind the corneal surface of the eye; however, a ray from the center of the physical pupil does not arrive precisely at the center of the pupil image. When the eye is looking away from the camera, the curved cornea refracts the rays from the various pupil edge points differently. Thus, as pupil diameter varies concentrically about its true center, the edges in the pupil image move nonconcentrically around the true pupil center point, even if the true pupil center is stationary.

Preferably, the illuminators are placed close to the optical axis of the imaging sensor, which causes the pupil to appear lit up, enhancing the camera's image of the pupil, which is called the bright pupil effect. Alternatively, in some cases, the illuminators can be placed away from the optical axis of the image sensor, causing the pupil to appear darker than the iris, called dark pupil effect (also called dark pupil eye tracking). Some pupilometers use both bright and dark pupil methods to calculate the gaze position and thus the pupil center.

The identification of pupil center and then the pupil diameter can be obscured by the movement of the head along the camera axis. Some remote pupilometers based corneal reflection technologies further include some types of head restraint to prevent head movements to improve the accuracy of the measurement. In some more preferred embodiments, the pupilometer takes account of the head motion by measuring variations in the range between the camera and cornea of the eye, and then it uses the range information to minimize gazepoint or pupil center errors resulting from longitudinal head motions.

The preferred pupil response measurement system might further include one or more computers, to which the pupilometer is preferably attached through some electronic means, such as electronic wires, optical wires or through wireless transmission. The pupilometer's image processing software then can be installed in the computer to process and analyze the pupillary response data. Further, the illuminators, infrared LED embedded in the infrared video camera, can be placed next to or on the computer monitor in an unobtrusive way, typically below the monitor, to better observe the participant's eye without distracting the participant. The system may have a sampling rate of 50 or 60 Hz: If it operates at 60 Hz it may have a camera field rate of 60 Hz or 120 Hz, and then the image processing software can compute the raw data each 60^{th} or 120^{th} of a second in synchronization with the field rate of the video camera.

In selecting a suitable pupillary response measurement system, the first criterion is the accuracy and sensitivity needed to measure and detect the differences between cognitive efforts associated with varying difficulty levels of the stimuli in order to be able to assess the linguistic comprehension level of the patient. It is also important to consider the requirements of the system in relation to the needs of patients being tested. For example, some systems require a fixed head position to separate eye movements from head movements for high spatial accuracy. Such systems would be appropriate for young, neurologically unimpaired adults, who are highly cooperative and would tolerate restraints to restrict head and chin movement and use a bite-bar to help fix the head. These systems, however, may not be tolerated by adults with physical or cognitive impairments, some older adults or very active young children for whom remote pupillary systems may be more appropriate.

Good head control is another consideration, however, and if participants are unable to tolerate a fixed-head system, then head-mounted (or a remote system that corrected for head movement) may be required. If patients must wear helmets or other headgear unrelated to the testing process, this may limit the use of head-worn hardware. The use of eye glasses also must be considered: For some systems reflections from eyeglasses interfere with performance accuracy. In fact, data collection with some individuals may be difficult on any system. If individuals blink excessively, that interferes with data collection.

Pupillary response systems that are unobtrusive, such as remote systems, may be preferable in some natural settings, but with less physical control, the clinicians sacrifice spatial measurement accuracy. Since the assessment tasks in the present invention can be executed with little or no movement, if the participants are alert and cooperative, then it may be preferable to explore systems with chin rests or other restraints to limit head movement so long as it does not induce any non-cognitive pupillary response that might mask TERPs. In some cases, the effect of such restraints can be examined in the baseline tasks and then subsequently removed through the subtraction method.

Furthermore, the different pupillary response systems differ in the amount of time required to position and adjust system-related hardware. For example, if a particular system requires the use of a bite bar, this will add time to the set-up. If portability is required, it is a good idea to consider a system that could be installed on a cart that may be moved to different testing or assessment areas. Some systems operate best under special lighting conditions and the luminance levels must be considered. Typically, incandescent light (generated by standard light bulbs) contains some infrared components and thus is not preferred because it may degrade performance accuracy.

In the examples of the present application, the pupillary response system used was an LC Technologies Eyegaze system, which is a remote pupil center/corneal reflection system. The system entails the use of a near-infrared light shone on one of the participant's eyes. Two points of the light's reflection on the eye, one from the pupil and the other from the cornea, are recorded via an analog video camera (located below the computer monitor in FIG. 2) with a sampling rate of 60 Hz. The video signal is then digitized, enabling a vector calculation of the pupil center and pupil diameter relative to the visual display based on the two points of reflection. Calibration procedures involve a patient viewing a series of five or more blinking dots on the screen from a distance of 34 inches from the monitor. The system can also track eye-fixation and durational data. The pupillary response system compensates for minor head movements via the Edge Analysis system, which uses the patented Asymmetric Aperture Method to measure variations in the range between the camera and the cornea of the eye, and then uses the range information to minimize gazepoint tracking errors resulting from longitudinal head motions.

Referring again to FIG. 1, the next step 15 of the inventive method is dependent upon whether the patient's linguistic comprehension is to be assessed on the basis of verbal comprehension or on the basis of the reading comprehension. If linguistic comprehension is to be assessed on the basis of verbal comprehension, a clinician initiates a first comprehension assessment trial by providing the patient with a pre-recorded verbal stimulus (also called auditory presentation). It is contemplated that various other methods of auditorily presenting the verbal stimulus to the patient can alternatively be used so long as the auditory presentation can be done uniformly and without causing undue excitement in the patient to mask or interfere with the measurements or analysis of task-evoked responses of the pupil (TERPs).

Pupil dilation can respond more significantly to factors other than cognitive processing, such as light, close-up objects, and emotional factors. So, the list is preferably presented to the patients through an auditory means so as to avoid any visual impact on the pupillary response (also called auditory stimuli). Auditory means can be an actual person speaking the word or sentence. Preferably, in order to maintain a relatively uniform effect of the auditory stimulus on various participants, pre-recorded auditory versions of the verbal stimuli are used. For example, to North American patients, the auditory stimuli are recorded by an adult male native speaker of American English. This avoids the distraction offered by a foreign accent to the North American English speaking patients. Of course, if patients are speakers of British English, the speaker may be British. To reduce environmental noises, the recording can take place in a sound-proof booth using a high-quality microphone directly connected to a PC. Further, the speaker records each word or sentence multiple times in uninterrupted strings. The token with the best quality in terms of articulation and word-level stress is selected by one or more listeners in some kind of agreement (for example, 100% agreement). Then each verbal stimulus can be further digitized, normalized for intensity, and stored on the computer for repeated usage. The participant can listen to the recording through a speaker or through a headphone.

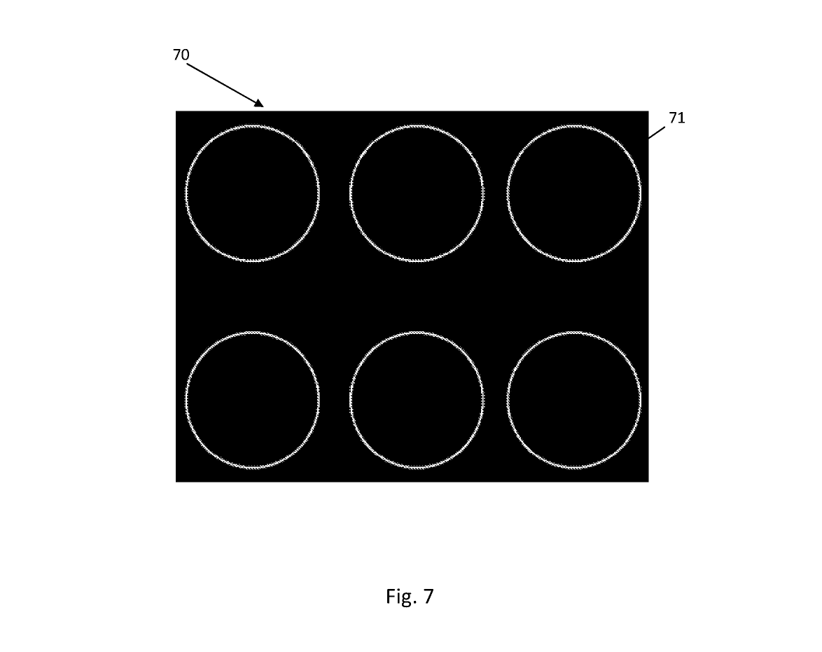

In a more preferred embodiment, while the audible verbal stimuli are presented to the patient, the patient is instructed to look at a fixation point (see FIG. 2). The fixation point can be a dot or dots, a circle or circles, or a square or squares, any simple figure, letter, shape or drawing that would merely provide a fixation point for the gaze of the patient for the ease of measuring the pupillary responses of the patient during the auditory presentation process (similar to the filler stimulus illustrated in FIG. 7). The fixation point should not be any image or figure that would distract the attention of the patient from listening to the auditory presentation of the verbal stimuli. Further, the fixation point should be similar in luminance to any other image to be displayed so as to prevent any pupillary change due to change in luminance. More importantly, the fixation point should not elicit any cognitive processing, such as the use of a usual geometric figure or drawing or letter, which would mask pupillary responses related to the processing of the auditory stimuli. Preferably, the patient will be instructed to “Listen to the words and sentences while you look at the dot on the screen. Be sure to listen carefully and pay attention to the meaning of what you hear.”

The pupil response data are measured and recorded for each verbal stimulus during the presentation of the stimulus, preferably for a period of time ranging from 200 milliseconds to 10 seconds. More preferably, the period of time ranges from 300 milliseconds to 4 seconds. In order to keep the time frame consistent between the tasks or each stimulus presentation, there preferably is a time window in the range of 2 to 4 seconds between the offset of one auditory stimulus and the onset of the next.

If the patient's linguistic comprehension is to be assessed on the basis of reading comprehension instead of verbal comprehension, assessment trials are administered in a similar manner to that described above except that textual stimuli versions of the verbal stimuli are presented to the patient in the center of the visual stimuli displays (see FIG. 2) and other considerations described in detail below. A patient is simply instructed to read the text displayed in the middle of the screen, and the patient's pupillary response data are recorded and assessed in the manner described above.

The textual presentation of the verbal stimuli involves presenting words to a patient visually through a written text. For example, instead of saying “banana” to a patient, the written word “banana” is presented to the patient textually/orthographically. In some embodiments of the present invention, the verbal stimuli can be presented to the patient auditorily and textually/orthographically at the same time or sequentially. For example, the word “banana” can be spoken to the patient while the text of the word can be presented to the patient simultaneously or immediately thereafter.

The words can be written on a paper, a board, or be put on a computer screen. Then, the presentation of the word to the patient is preferably controlled so as to minimize the impact of the light and color on close-up objects on the pupillary response of the patient, to avoid confounding the results. Light and color may have significant impact on pupillary responses of a patient. The magnitude of pupillary light reflection (pupil diameter may range from one to nine mm) is much larger than the magnitude of TERPs (usually less than 0.5 mm) (Beatty & Lucero-Wagoner 2000), and can thus mask TERPS. For example, according to Steinhauer, Siegle, Condray, and Pless (2004), the magnitude of the pupillary dilations differs for the difficult tasks between light and dark conditions. To reduce or control the visual impact or influence on the pupil response of the patient, the text of the word is preferably written in black and white. When the text of the word is presented on a computer screen, the luminance of the computer screen is preferably adjusted to an ambient level. Further, the light is preferably controlled by adjusting and/or monitoring ambient room lighting and/or any visual stimulus items with a light meter. The accommodation reflex, which involves bilateral constriction of the pupils in response to images within 4 to 6 inches of a patient's nose, can be easily controlled by placing any visual stimulus items greater than 6 inches away from the patient's nose.

Referring again to FIG. 1, the final step 17 of the inventive method is analyzing and interpreting the pupillary response data for all verbal stimuli presented through the above test protocols. The pupillary response data relative to the cognitive effort are called “task-evoked responses of the pupil” (TERPs). TERPs are defined as “a time-locked averaged record of pupillary dilation and constriction occurring during the performance of a mental task” (Ahern & Beatty, 1981, p. 122). TERPs occur shortly after the onset of processing, typically within 100-200 milliseconds, and then subside quickly following the termination of processing. Dilation and constriction of the pupil are controlled through the radial (dilator) and circular (constrictor) muscles of the iris, which are governed by the autonomic nervous system, which regulates cortical arousal. These responses are not under volitional control, and thus, the response cannot be controlled or modified by the patient as it can be done by eye-fixation methods. Therefore, the results can be relatively free of confounds associated by the patient's intentional control of the response that is not related to the patient's linguistic comprehension level, to avoid confounding the results of the assessment.

Kahneman (1973) suggested that pupillometry can be used to assess task difficulty. The studies have been done on correlation between pupillometric indices and various cognitive or linguistic tasks according their difficulty levels. However, tasks used are based on memory, such as memory loads for words and digits, and on uncommon linguistic manipulations, such as letter discrimination and cross-linguistic interpretation. These tasks are not common or everyday linguistic usage, requiring more intensive cognitive efforts and thus larger pupillary responses, which might not correlate to the difficulty levels associated with regularly used words. For example, unusual words or less frequently used words are considered more difficult, thus requiring more effort to recognize and/or comprehend. In addition, these relatively large pupillary responses are likely also caused by factors other than linguistic comprehension, such as emotional factors (excitement over the unusual way of using language) or other linguistic skills (short-term memory skills), understanding of the task instruction, and/or level of education needed to understand the linguistic task.

Moreover, these tasks are not likely to result in pupillary data that can be analyzed to show a patient's actual linguistic comprehension level so as to assess whether the patient has a linguistic impairment or even the impairment level as compared to a person without neurological impairment. More importantly, because the pupillary response to the task exertion or effort is relatively slight, the effects of other factors, such as light, memory, or understanding of instructions, can easily mask the responses from TERPs. In other words, many variables can reduce the validity and reliability of the responses from task-evoked pupillary responses. These responses include both physical variables and psychological ones. Relevant physical variables include, but are not limited to, general peripheral system differences between patients, distance from the object, and the effects of light and brain injury on pupillary responses. Relevant psychological variables include, but are not limited to, anxiety, fear, and other emotional response that can contribute to potentially confounding factors. All these variables can be attributed to patient, stimulus, and environmental conditions. More importantly, these factors can affect the pupil dilation, which can impact the accuracy of any pupillometric experiments. It is difficult to control these variables to minimize their impact on the task-evoked pupillary response while preserving and enhancing the sensitivity of the task-evoked pupillary response to relatively small effort exerted in the normal everyday linguistic processing. The present invention is able to provide valuable information regarding individual differences in cognitive and linguistic abilities for clinical assessment despite the numerous factors that can influence TERPs values, and can also be used as the basis for the formation of treatment plans for impaired patients.

While it is difficult to assess accurately any individual's linguistic comprehension, the assessment of linguistic comprehension in patients with stroke and/or brain injury (injuries) is even more difficult. Concurrent with possible or actual impairment of linguistic comprehension, these individuals more often than not have impairments of attention, vision, and motor function, contributing to the existence of many confounds, hindering the accurate assessment of the linguistic comprehension level even if to find out whether or not the individual has any linguistic comprehension impairment. The present invention is able to use pupillometry to accurately assess the linguistic comprehension level of individuals for even relatively easy words and sentences, and to evaluate whether the individuals have any linguistic comprehension deficit compared to individuals without neurological impairments.

In the present invention, the magnitude of pupil dilation as related to cognitive effort is measured in several different ways: by obtaining a simple maximum measure—the single highest amount of dilation observed during a set time period, by calculating a mean or average, pupil dilation over a response interval, and by measuring the latency to peak—the amount of time it takes a participant to reach peak pupil dilation during a task.

TERPS can be calculated in three different ways in order to compare significant results across computation methods: absolute values, subtracted values, and normalized values. Pupillary response data (also called “dependent measures”) consist of mean pupil diameter, maximum pupil diameter, and latency to maximum pupil diameter for the absolute value, subtracted value, and normalized pupil data. Commercial or custom software can be used to extract data related to dependent measures.

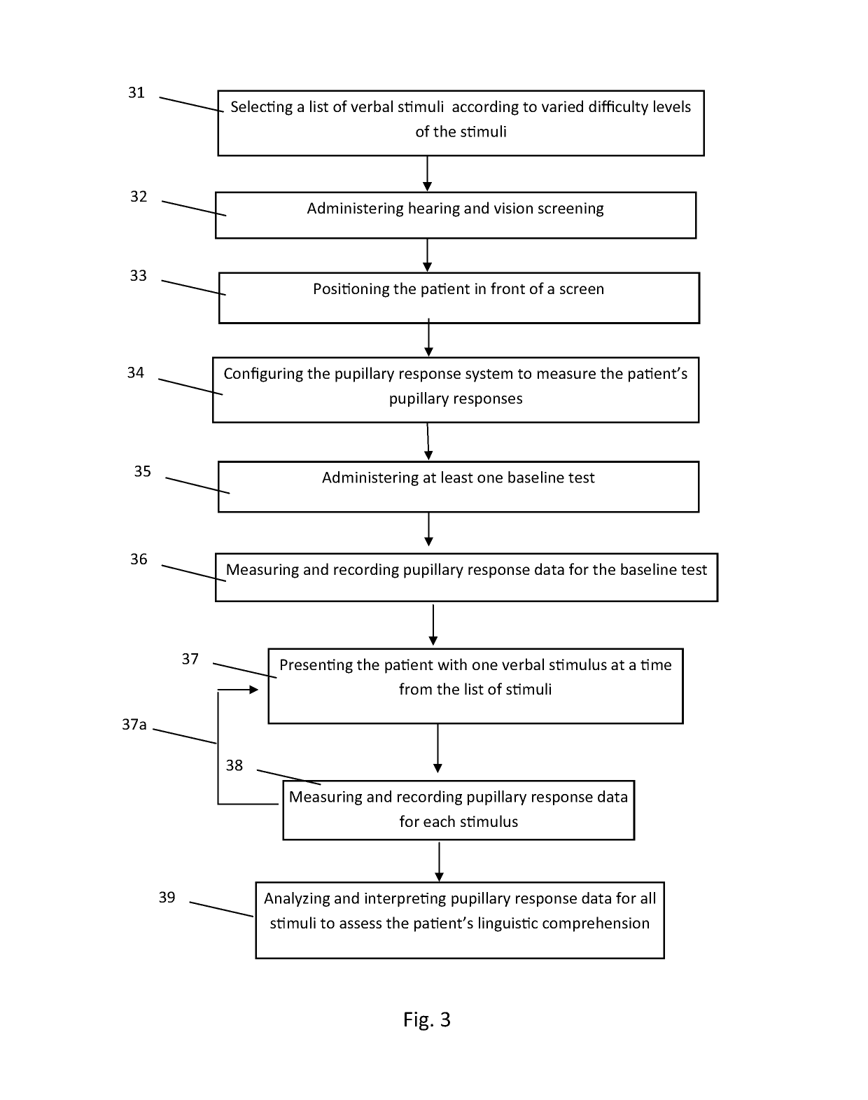

For absolute values, mean and maximum TERPs can be reported as millimeters of pupil diameter, rather than a change in dilation. In the subtraction method, the average pupil diameter obtained during a baseline task will be subtracted from mean and maximum TERPs in order to obtain the amount change, in millimeters, induced by the assessment tasks. The baseline task as illustrated by FIG. 3 is often used to obtain the baseline measures of each patient's pupillary responses so that emotional effects can be controlled by subtracting the baseline pupil diameter from the TERPs, resulting in the measurement of relative increase in pupil dilation due to experimental tasks alone. Latency of maximum pupil diameter for both methods will be reported in milliseconds between the initiation of each trial and the single maximum pupil diameter obtained within each trial.

In the normalization method, a grand mean pupil diameter is obtained by averaging all of the pupillary responses from each condition or task or for the entire experiment. A condition can be a task associated with a set of easy nouns, or a task associated with a set of difficult nouns. To obtain a normalized measurement of a mean pupillary response, divide each individual pupillary data point in the analysis time-frame by this grand mean for that condition or task. The normalized data will then be averaged at each time point over all participants to obtain a waveform of pupillary dilation in each condition. Then, normalized data can be submitted to an optional simple regression analysis with time as the independent variable and the normalized pupil data as the dependent variable in order to obtain the slope of pupillary change for each condition.

The mean pupil dilation measure is dependent on the time frame during which raw data for this measurement is calculated. In the present invention, the time frame is restricted to the completion of a certain portion of the task or to a maximum period. For example, the time frame is restricted to three seconds from a predetermined time period.

The peak pupil dilation measure is more sensitive to noise, but this measure is not affected by the total number of data points in the measurement period. From this measure, latency to peak measure can be calculated based on the amount of time it takes a participant to reach peak pupil dilation. This latency to peak measure allows the clinicians to observe when a participant's cognitive processing is at a peak, which often occurs immediately preceding the completion or resolution of a task.

Custom computer software runs the experimental protocol described above for the auditory or textual presentation of the verbal stimuli to the patient. The software governs the initial calibration of the patient's eye movements and eye configuration. Additional custom software is preferably used to analyze raw eye-fixation, pupil center, and pupil diameter measures. For example, the raw eye-fixation is x/y coordinates corresponding to where a patient's eye is focused on the computer monitor, and the raw eye-fixation measures can be used to obtain more accurate measures of pupil center and pupil diameter to accommodate for minor head and/or eye movements.

Control of Non-Cognitive Factors and Baseline Test:

In some preferred embodiments as illustrated in FIG. 3, a baseline test in step 35 is administered prior to and/or immediately after the experimental tasks in steps 37 to 38 (also called “assessment tasks”). In FIG. 3, the baseline test is administered 35 immediately prior to the experimental tasks in steps 37 to 38. The pupillary response during the baseline task can be measured and recorded 36, and then be used as the baseline value for each individual trial or for analysis of the pupillary values for all stimuli in step 39. While not wishing to be bound by theory, it is presently believed the baseline values can be used to control emotional effects in order to obtain the measurement of relative increase in pupil dilation due to experimental tasks alone.

As discussed above briefly, pupil dilation (also called pupillary response) responds to many factors other than cognitive process, including both physical variables and psychological ones. Relevant physical variables include, but are not limited to, general peripheral system differences between participants, distance from the object, and the effects of light and brain injuries on pupillary responses. Relevant psychological variables include, but are not limited to, anxiety, fear, and other emotional responses that can contribute to potential confounding factors, which can affect the pupil dilation and the accuracy of any pupillary experiments.

The present inventive method attempts to control several variables so as to increase or heighten the probability that measures designed to measure TERPs provide valid and reliable responses. Emotional factors may be somewhat difficult to control because every individual reacts differently to testing or assessment environments. The baseline test is one of the preferred ways to control the emotional effects in order to obtain TERPs due to experimental tasks alone.

Light is preferably controlled in the present method by using a light meter to monitor ambient room lighting as well as luminance of any visual or textual stimulus items. The accommodation reflex, which involves bilateral constriction of the pupils in response to images within 4 to 6 inches of a patient's nose, can be easily controlled by placing any visual stimulus item greater than 6 inches away from the patient's nose.

The visual stimuli are preferably designed so as to minimize the presence of distracting visual features. Distracting visual features include color, shading, background, size and luminance. As such, the visual stimuli preferably consist of black and white images, in which the shadings are minimized as much as possible without degrading image quality. A white background and a standard size are used. The visual image can be put on a board, a paper, a computer screen, or other similar device. If the visual image is put on the computer screen, the luminance should be controlled and monitored through a light or luminance meter.

Preferably, the baseline measures of pupil diameter of the patient were obtained prior to the initiation of the above tasks. The baseline measures are used to control emotional effects on the pupil diameter so that the resulting pupil diameters are analyzed relative to the baseline results either by subtraction or other similar methods. As with most physiological measures, TERPs index the change in the pupil diameter induced by the task, not the value of the pupil diameter in absolute terms (although comparisons of pupil diameters in absolute terms can also be used under the assumption that TERPs are stable over baseline values). The baseline measurement is preferably obtained when no cognitive processing is taking place. The complete absence of cognitive processing is unlikely; however, it is important that any condition or task used to obtain baseline diameter is as neutral as possible, and that it especially does not induce the type of processing that the experimental tasks are intended to measure. A “condition” refers to a specific set of stimuli designed to elicit a certain pupillary response due to a certain level of cognitive effort associated with processing this set of stimuli. For example, a set of easy nouns is a condition, while a set of difficult nouns is another condition. Similarly, a set of easy sentences is a condition; while a set of difficult sentences is another condition.

Baseline tasks can be simply looking at a blank, lighted display for a period of time prior to experimental or assessment trials. However, the luminance of a blank and lighted screen may be different than the luminance of a computer screen containing images, resulting in possible or potential confusion between light-induced pupillary responses with task-induced pupillary responses. If patients view a blank white computer screen, for example, the luminance of the blank screen may be higher than the luminance of images that may be presented later in which some portions of the screen are black or shaded. Problems ensuring luminance consistency may be avoided by manipulating all stimuli so that luminance values are similar across all tasks.

Preferably, the baseline tasks should contain similar visual stimuli as that of the assessment task. The similar visual stimuli can be a similar word, similar sentence, or similar image. Any difference between the baseline task and the assessment task must be monitored or adjusted so that it would not induce any processing that could obscure TERPs. Alternatively, the similar visual stimuli can be all crosshairs instead of actual words. This choice might maintain equal luminance while reducing any sort of linguistic processing that might take place while reading a “neutral” or similar sentence or word.

Preferably, the visual stimuli used in the baseline task are all of the actual visual stimuli to be used throughout the assessment test. This way, the baseline pupillary response will be the amount of pupillary change elicited by the visual stimuli alone without any processing of the word. That is, the patients to be assessed can be presented with all images that are later used in the assessment task or test without any accompanying verbal stimuli, and without providing any instructions other than “Look at the images.” Although it is impossible to control what the patients might be thinking as they are exposed to these images, it is believed that the differences in pupillary dilations during the task might be in relation to luminance alone without any processing elicited by a language task.

The placement of the baseline task within the overall experiment is also important to consider. The pupillary response during the baseline task can be measured before and/or after the assessment task, and then be used as the baseline value for each individual trial. This may be an effective way to ensure that baseline pupil diameter is not affected by any anxiety over the task or by pupillary dilations sometimes elicited by response preparation. Alternatively, the baseline measurement can be obtained for each individual trial. This method of baseline measurement has an advantage in that any residual processing related to any specific trial or any anxiety related to the specific trial will be taken into account in the measurement of the TERPs.

Control of Patient's Attention—Comprehension Test.

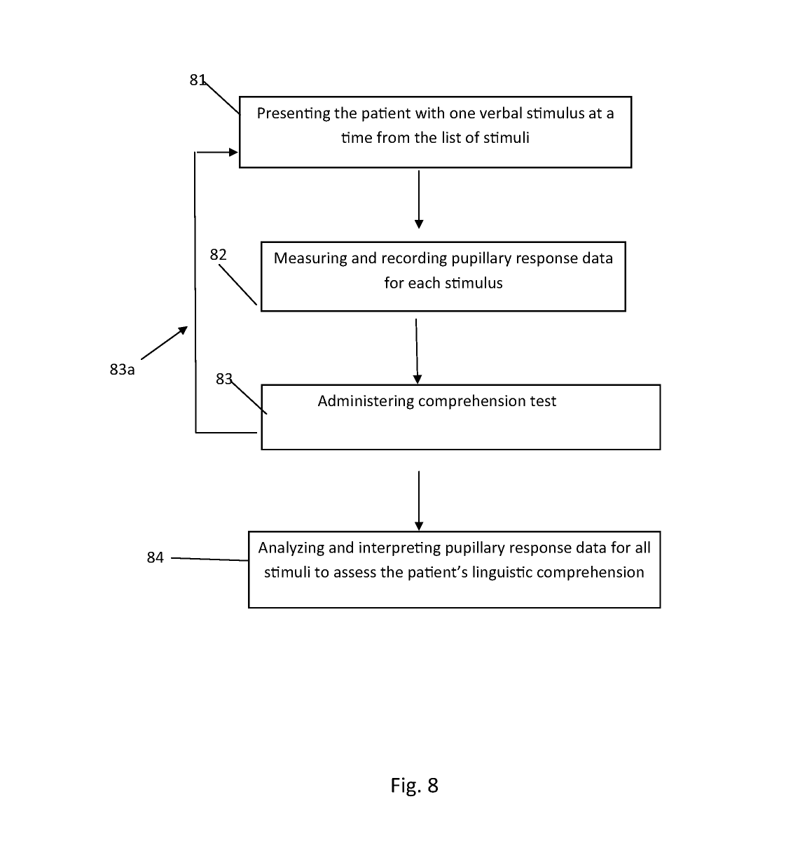

In some further embodiments of the present inventive method, the experimental tasks can further include an optional attention retaining component, such as a comprehension test, as illustrated in FIG. 8. While not wishing to be bound by theory, it is presently believed that a comprehension test can be used to keep the patient's attention focused on the task during the assessment. The comprehension test comprises asking simple comprehension questions by a clinician or an examiner. The experimental tasks can include about 10 to 30% of the comprehension questions.

It is contemplated that various other measures can alternatively be used to maintain or focus the patient's attention during the experimental tasks. For example, the patients for the test can be instructed in the beginning that they will be asked to recall as many stimuli as possible, or that they will be required to answer questions regarding the stimuli that were viewed during the test. It is not necessary to actually include these follow-up tasks, or to analyze any results obtained from them if they are included. This type of instruction can be used as an alternative to the comprehension test to ensure active listening by patients, and may or may not lead to more sensitive measurement of pupillary movements. Other ways of possibly eliciting more active attention would be to add a decision-making task, such as a button-press if the stimuli are matching or nonmatching. However, the addition of this motor-based task will increase the likelihood of confounds for patients with aphasia, due to the hemiparesis and/or hemiparalysis that often occurs concurrently with language impairments due to stroke. It may be valuable to integrate a decision-making task with eye tracking measures, such as point-of-regard measures, which would provide researchers or clinicians with accuracy data and increase active attention in participants without introducing confounds related to motor or verbal responses.

### Verbal-Visual Stimuli Method

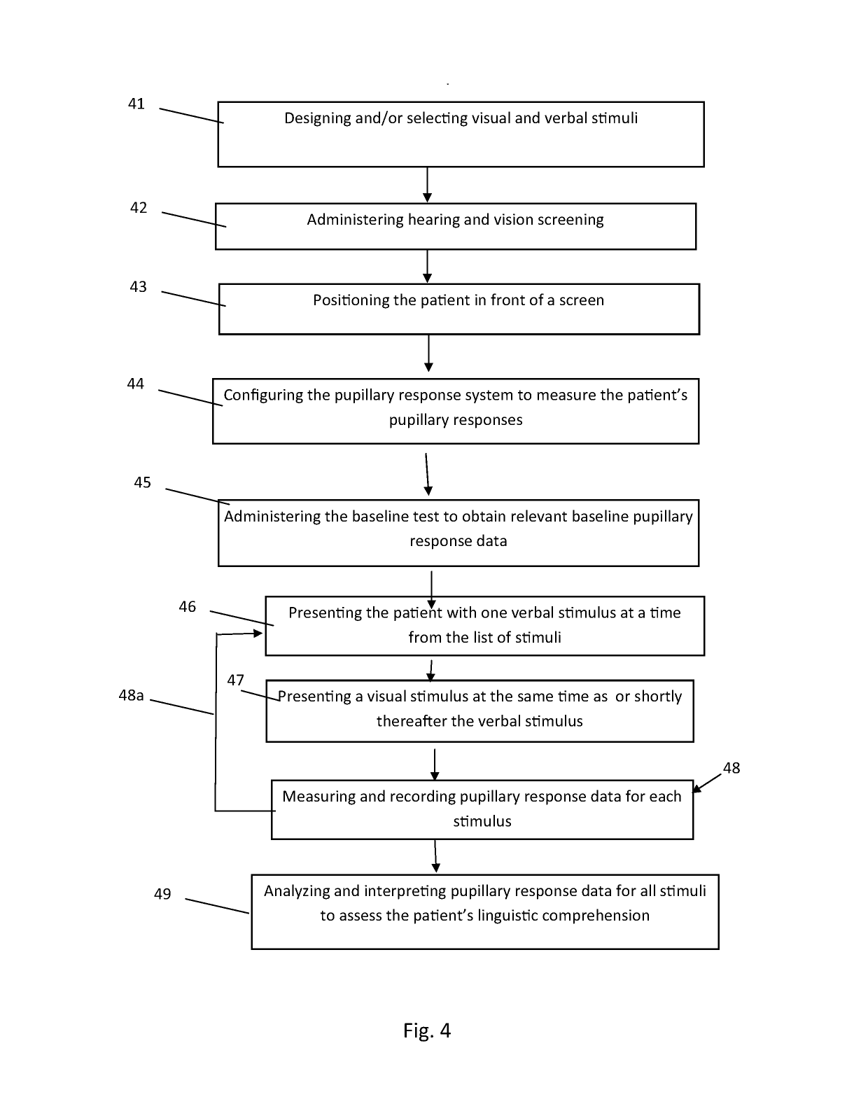

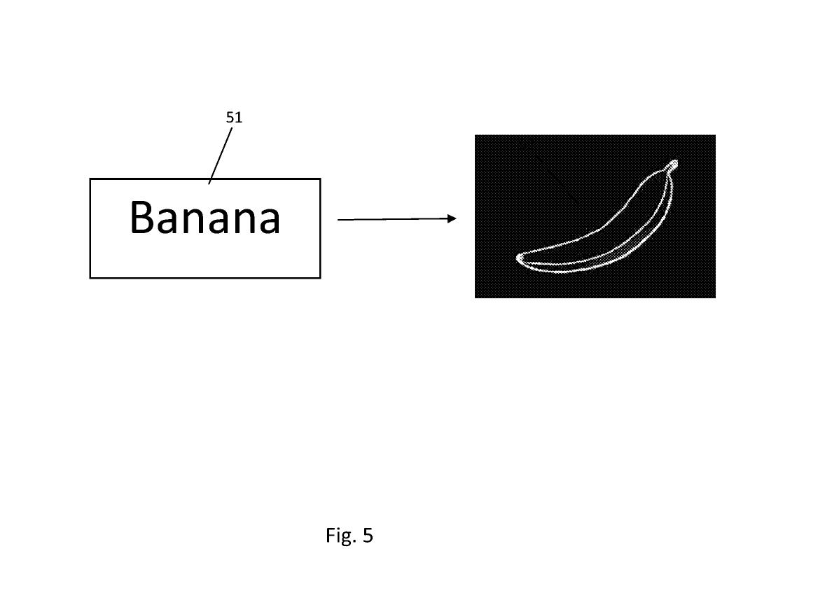

In some alternative embodiments of the present inventive method, the presentation of the verbal stimuli can also be accompanied by the presentation of the visual stimuli either simultaneously or immediately thereafter (see FIG. 4). Broadly, the method includes the steps as illustrated in FIG. 4. Referring to the first step 41 of the method for using the combination of visual and verbal stimuli to assess the linguistic comprehension level of the patient as set forth in FIG. 4, each visual stimulus includes at least one image that corresponds to the verbal stimulus being presented at the same time as or immediately prior to the visual stimulus. Preferably only a single image is presented to the patient along with the presentation of a single corresponding verbal stimulus (a word or a sentence) as shown in FIG. 5. The verbal stimuli are varied in terms of word difficulty and also whether or not they match the image shown.

Next, the patient is preferably administered hearing and/or vision screenings 42 followed by positioning the patient in front of a screen 43 and configuring the pupillary response system to measure patient's pupillary responses 44, all which are substantially the same as described in detail in the above section. Similarly, a baseline test 45 is preferably administered to obtain relevant baseline pupillary response data to minimize or eliminate the effect of emotional or other environmental factors on the analysis of TERPs, the process of which is substantially the same as described in detail in the above section.

In the next steps 46 to 47 as set forth in FIG. 4, a verbal stimulus from the list of the verbal stimuli is presented to the patient 46 while a corresponding visual stimulus is presented to the patient at the same time or immediately thereafter 47. Pupillary responses are measured and/or recorded 48 during the presentation of the visual stimulus. The steps 46 to 47 are repeated 48a for each pair of verbal-visual stimuli in the list, and then the pupillary response data are analyzed and interpreted 49 in substantially the same way as described in the above section.

For example, after the patients are seated on chairs at a suitable distance from the computer (see FIG. 2), the patients can be instructed to “listen to the words and look at the pictures on the screen.” The word “banana” is spoken to the patients, and at the same time the image corresponding to the word, an image of “banana,” appeared on the screen (see FIG. 3). The patients are given a period of time, ranging from about 200 milliseconds to about 10 seconds, to view the image before the computer automatically advances to the next stimulus item. The viewing time frame provides the patient with ample time to process the stimulus. Task-evoked pupillary responses have been shown to occur within 100-200 milliseconds following the onset of the cognitive processing, and then quickly subside following the termination of the processing.

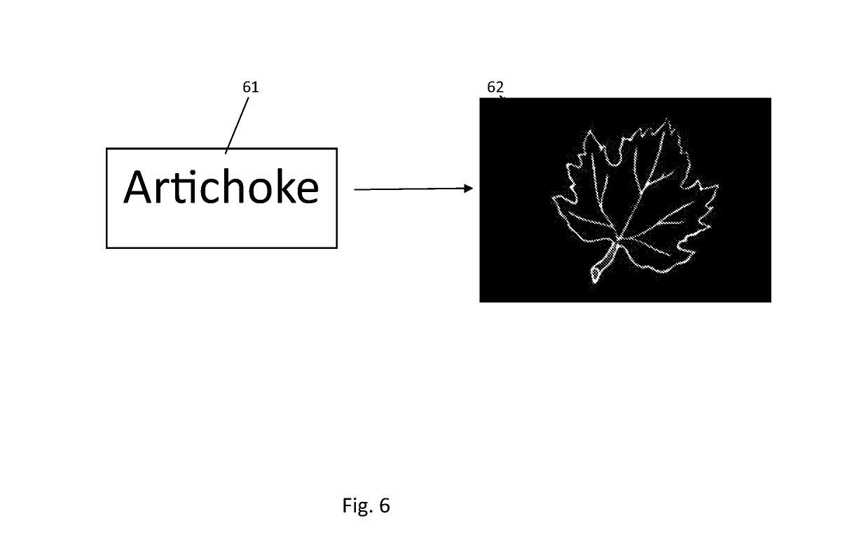

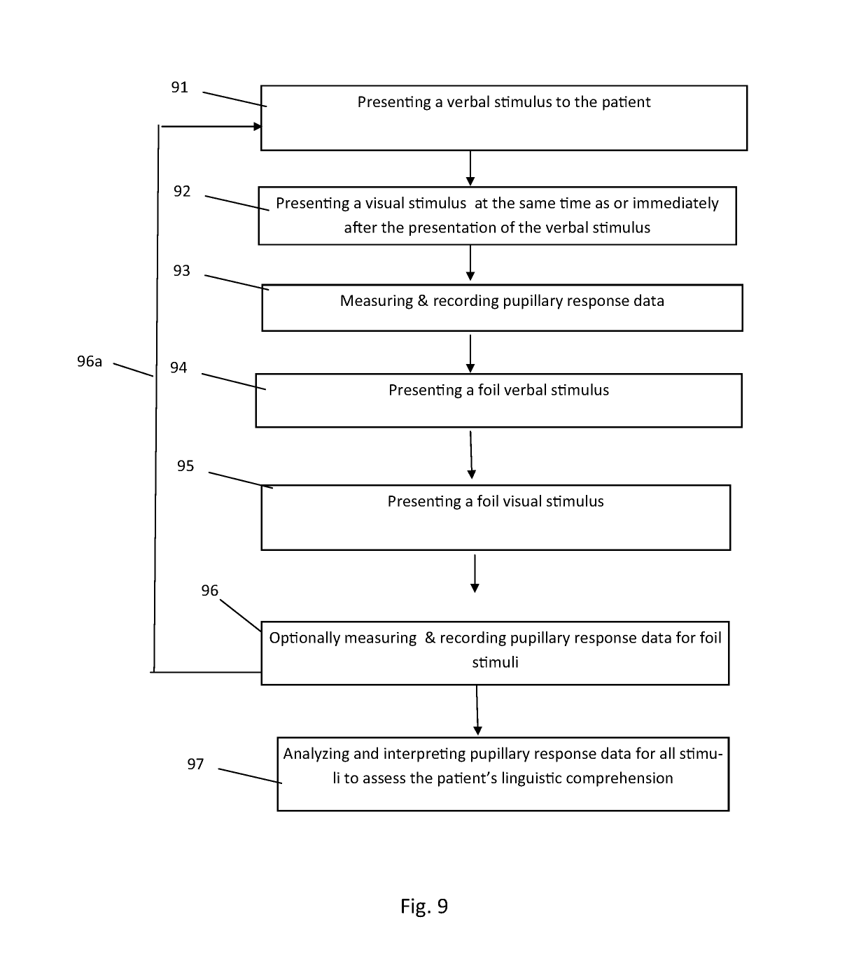

Foil Stimuli Trials. During the assessment test, the patient's attention may drift away from the task at hand. To keep the patient focused on the task, optional foil trials are inserted into the task as set forth in FIG. 9. The pupillary response data for the foil stimuli can be measured, recorded and analyzed to understand more about the patient's cognitive ability. Further, these data are compared to the pupillary response data for the experimental tasks for more in-depth evaluation of the patient's linguistic comprehension according to different difficulty levels of the stimuli. Foil trials are trials in which the visual and auditory stimuli do not match. For example, in FIG. 6, the patients hear the word “artichoke” 61 but see an image of a leaf 62, rather than seeing the corresponding image of “artichoke.” These foil images are inserted to add an unexpected element to the assessment test. This is intended to help prevent boredom and ensure that the patients maintain attention throughout the test. The foil stimuli should be similar to the stimuli used in the test in terms of complexity and other factors. For example, for single word stimuli tests, the same verbal stimuli and visual stimuli are used but are paired differently so that the visual stimuli do not match the verbal stimuli. Preferably, 10 to 30% of the assessment test should consist of the foil trials; more preferably, 20% of the test consists of the foil trials.

Filler Stimuli.

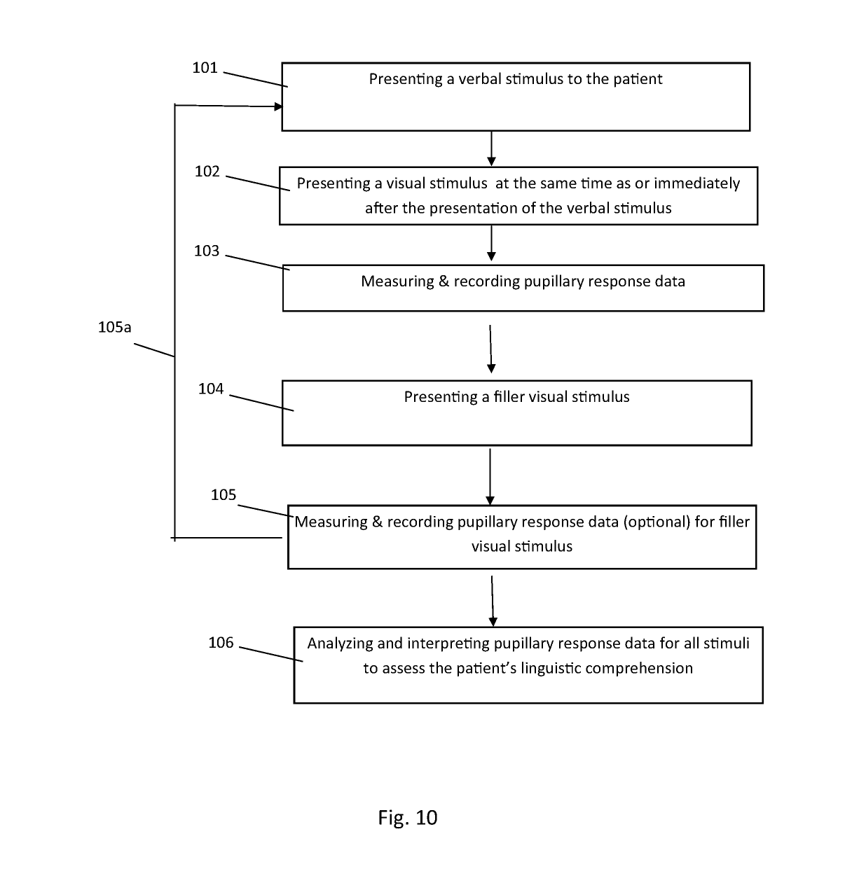

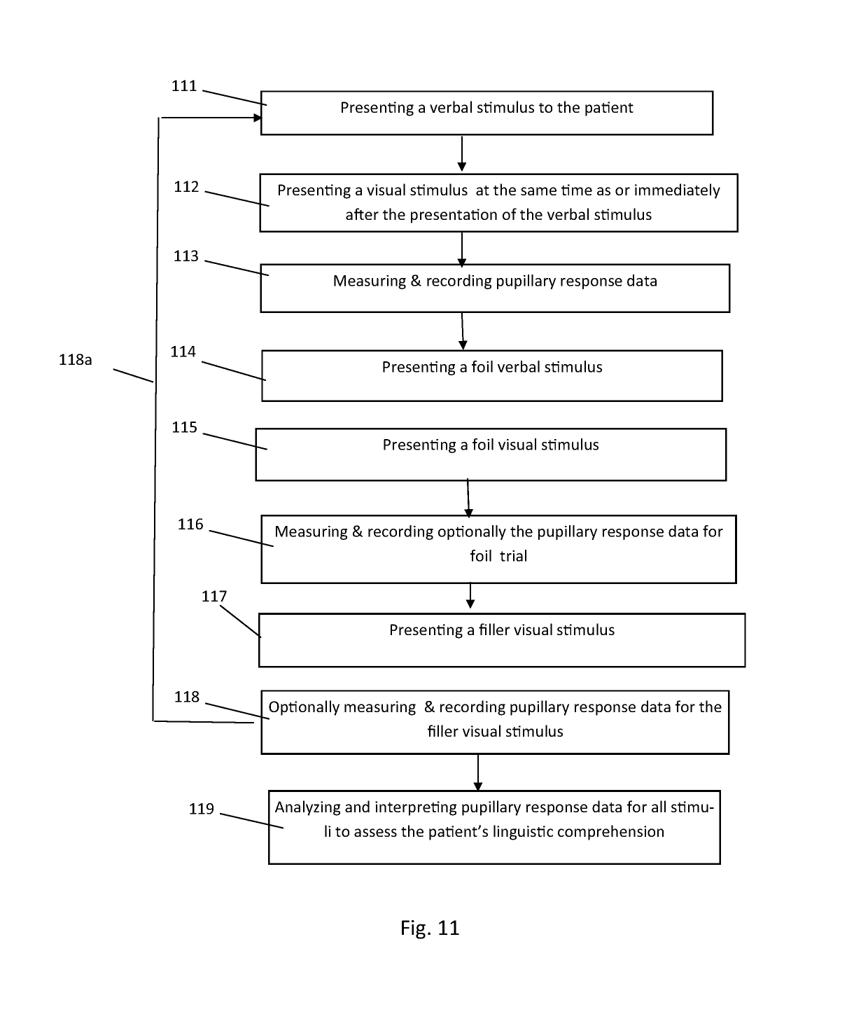

In addition, optional filler stimuli can be interspersed in the assessment test in order to prevent pupillary changes due to an abrupt change in luminance between trials as shown in FIGS. 10 and 11. Filler stimuli and the foil stimuli can both be included in an assessment test as shown by FIG. 11.

Similar to the fixation point used in the auditory stimuli only assessment task, the preferred filler image can include one or more dots, one or more circles, one or more squares, one or more simple letters (such as “X”), or other similar shapes/letters/drawings/figures. It is important to note that the filler image should be similar in luminance to any other images shown to prevent pupillary changes due to change in luminance. More importantly, the filler image should not elicit any cognitive processing, such as the use of a usual geometric figure or drawing or letter, which would mask pupillary response related to the processing of the auditory stimuli. Preferably, 10 to 30% of the test preferably consists of the filler image.

### Stimulus Selection

Words

As mentioned above, verbal stimuli can be words or sentences. Verbal stimuli can be presented to patients audibly or textually by themselves; or alternatively, the verbal stimuli can be presented with the corresponding visual stimuli to the patient. In order to use the pupillary response of the patients in relation to their linguistic cognitive efforts to assess their linguistic comprehension, the verbal stimuli are separated into two or more sets of verbal stimuli with substantially different difficulty levels. Preferably, there are two sets of verbal stimuli with substantially different difficulty levels, such as one set being substantially easy while the other set is substantially difficult. Stimuli that have a clear delineation between “easy” and “difficult” can be used reliably to assess the degree of correlation with TERPs. More importantly, this behavior measure may lessen the potential influence of many confounds associated with people with neurological impairments, such as speaking or limb-motor deficits.

The selection of the words as the verbal stimuli of the present invention according to these differing levels of difficulty are based on several criteria: age of acquisition, word frequency, familiarity, naming latency, length of the word, pronunciation, other similar factors or criteria, or combinations thereof. Some stimulus words (nouns) may be selected from the Snodgrass and Vanderwart (1980) word set. Corresponding visual stimuli may be found in the Rossion and Pourtois (2004) image set. These images, based on images from the original Snodgrass and Vanderwart (1980) image set, may be preferred because computerized images are available, which allow for manipulation of the images to reduce differences in luminance.

Preferably, the words are selected according to the estimated difficulty so that each word fits clearly into one of two categories: easy or difficult. Combinations of four types of measurements (criteria) are preferably used to approximate word difficulty: age-of-acquisition estimates, word frequency measurements, word familiarity estimates, and naming latency measurements.

Estimated age-of-acquisition is known to be the chief determinant of naming latency. Carroll and White (1973) determined age-of-acquisition of 220 images by asking participants to estimate when they had first learned a word and its meaning in either spoken or written form. Words that were judged as being learned earlier by participants were named faster than those words that were judged to have been learned later. In 1996, Snodgrass and Yuditsky obtained age-of-acquisition estimates for 250 images in the Snodgrass and Vanderwart (1980) word set using the procedures described by Carroll and White. Preferably, age-of-acquisition estimates from Snodgrass and Yuditsky (1996) can be used for the image and words chosen for the assessment test or study.

Word frequency has been shown to correlate highly with the difficulty level of a word. The assumption with regard to word frequency as it relates to the difficulty of a word is that difficult words are likely to appear less often, and words that are more commonly encountered will be learned faster and remembered better. Breland (1996) found that the correlations between the word difficulty estimates and the word frequency indices are high. Word frequency measurement for the present invention can be taken from the Kucera and Francis frequency norms ((Kucera & Francis, 1967). Reliable references can also be used to provide the word frequency measurement for estimate of the word difficulty in the present invention.

Familiarity ratings may be taken from Snodgrass and Vanderwart's study (1980). Familiarity ratings from other reliable studies may also be used. In Snodgrass and Vanderwart's study, participants were instructed to give 260 pictures stimuli familiarity ratings by asking them to rate “the degree to which you come in contact with or think about the concept” (p. 183). The participants were asked to rate the images on a 5-point scale, with a rating of 1 indicating very unfamiliar and 5 indicating very familiar. Results indicate that rated familiarity is positively correlated with frequency and negatively correlated with age-of-acquisition ratings. Therefore, words that are more familiar typically occur more frequency and are learned at an earlier age.

Naming latency measurement can be found from the 1996 study of Snodgrass and Yuditsky. Of course, measurements from other reliable studies can also be used. The assumption is that more difficult words result in longer naming latencies than easier words.

Means and standard deviations can be computed for each measurement (criterion) for the words in the Snodgrass and Vanderwart (1980) word set. Words falling either one standard deviation above or below the mean for each particular measurement (such as age-of-acquisition) are selected to allow for a substantial difference between easy and difficult words. Words within one standard deviation from the mean are preferably not selected because the difficulty levels are not sufficiently different. (1) For the familiarity rating measure, words that have more than one standard deviation above the mean for familiarity rating should be considered “easy”; words that are greater than one standard deviation below the mean should be considered “difficult.” (2) For the frequency measure, words that have more than one standard deviation for the mean for frequency estimates should be considered “easy”; words that have a frequency rating of zero are considered “difficult.” In the case for frequency estimate, due to the relation between the mean and standard deviation of the sample, it is not possible to obtain words one full standard deviation below the mean, so the frequency rating of zero is a suitable standard for words being considered as “difficult.” (3) For the age-of-acquisition measure, words that have more than one standard deviation above the mean for age-of-acquisition estimates are considered “difficult”; words that are greater than one standard deviation below the mean are considered “easy.” (4) For the naming latency measure, words that have more than one standard deviation above the mean for naming latencies are considered “difficult”; words that are greater than one standard deviation below the mean are considered easy.

In some embodiments, words that are classified as “easy” or “difficult” according to at least two out of the four categories are considered for final selection as “easy” or “difficult” words. The results from Example 1 show that this method of categorizing nouns as easy and difficult was reflected in TERPs. Alternatively, a composite estimate of word difficulty based on all four measures can be used, in which more weight is given to the age-of-acquisition measure. Example 1 also shows that age of acquisition appeared to be the most important indicator of word difficulty: age-of-acquisition was positively correlated with mean pupil diameter in both control patients and the patients with aphasia (PWAs). Easy and difficult word lists then are preferably balanced to include equal number of words consisting of one-, two-, and three-syllables in order to reduce the impact of word length to focus on the pupillary response to the difficulty level based on four measures only.

In some other embodiments, different measures of difficulty criteria, such as word length or pronunciation, or perceived difficulty, can be used. Or these measures can be added to the four above mentioned measures to further evaluate the difficulty level of the words.

Sentences

Easy and difficult sentences can be based on active and passive sentences, sentence length, sentence branches, number of verbs in a sentence, and imbedded clauses, respectively. For example, easy and difficult sentences may be based on active and passive sentences: an easy sentence can be an active sentence, while a difficult sentence can be a passive sentence. Sentences can be syntactically and semantically reversible so that if the subject-verb-object is ordered in one way, the sentence can be an active sentence; while if the subject-verb-object is ordered in another way, the same sentence can be changed into a passive sentence. This way, any potential confounds associated with different sentence content are reduced or eliminated, focusing the pupillary response on the difficulty level of the sentence as related to its active/passive structure.

The full passive form, including the use of “was” and “by,” can be used for all passive sentences in this study. Active and passive sentences, as well as visual stimuli, can be selected from the Verb and Sentence Test (VAST; Bastiaanse, Edwards, & Ripens, 2002) and the Eyetracking Picture Test of Auditory Comprehension (EPTAC, Hallowell, 2012), or other equivalent validated compilation or reports. The images from both VAST and the EPTAC have been validated to ensure that individuals interpret them to convey the linguistic construct they are paired with.

The key difference between active and passive sentences is the ordering of the constituents within the sentence. Active sentences, similar to many English sentences, are composed with the subject of the sentence appearing first, followed by the verb, then finally by the object of the verb. The subject-verb-object (S-V-O) ordering of thematic constituents within a sentence is termed the canonical, or standard, ordering of constituents in the English language. With this ordering, the subject of the sentence is typically assigned the thematic role of an agent, or the doer of the action. The object of the sentence, therefore, is typically assigned thematic role of the theme, or the person/thing that is undergoing the action. In contrast, thematic constituents in passive sentences are ordered non-canonically; the object of the sentence appears first, followed by the verb, followed by the subject (O-V-S). Therefore, the thematic assignments are reversed; the focus of the sentence is now the theme; and the agent follows the verb. Many studies support the notion that comprehension of sentences with non-canonical ordering of constituents, such as passive sentences, is more difficult than comprehension of sentences with a canonical ordering of constituents. This comprehension difficulty has been reported not only in people with aphasia, but also in children with language impairments, normally developing children, and younger and older adults without language impairments. Once easy and difficult sentence lists are compiled, they are preferably balanced for frequency, familiarity, and length (in terms of number of words).

Visual Stimulus Characteristics and Effects on Disproportionate Visual Attention

Color: Color functions as a distractor in image-based tasks. Colored items attract more immediate and longer attention when presented along with black and white items, or items that significantly differ in color. Deffner (1995) conducted a study of image characteristics considered critical in image evaluation. Participants were shown a series of images and were instructed to express their preferences regarding image quality. Color saturation, color brightness, and color fidelity were all items shown to influence how participants viewed images.

Size:

When viewing multiple images within one display, relative size is a physical property of images that influences scanning patterns. The size of a stimulus refers to the spatial extent of the item. The disproportionate size of an object is likely to attract disproportionate attention to images within a multiple choice display. The viewer is more likely to focus on the biggest or the smallest object in a display of several images.

Depth Cues:

Shading, highlight details, and shadow contrast have been shown to influence eye movement patterns when viewing images. Individuals allocate more attention or pupillary response to visual stimuli cued in depth through shadows, for instance, than to two-dimensional stimuli without depth cues. Disproportionate looking at a multiple-choice image display occurs when two dimensional images and images with depth cues are displayed together.

Luminance:

Barbur, Forsyth, and Wooding (1980) found that background color and luminance have an impact on viewers' visual scanning patterns. In their study numbers were recalled better using a middle-grey background instead of a black one. The correct performance of tasks also increased when the luminance of the background was greater than one-third of that of the target. Additionally, contrasts in luminance have been demonstrated to be recognized faster and also with higher frequency than changes in motion and complexity. Different degrees of luminance of images may cause a disproportionate pupillary response in multiple-choice displays. Likewise, luminance differences between the backgrounds of the images can influence the viewer's visual attention as well.

Clarity:

The time a viewer spends fixating on images tends to be greater when the image is blurred than when it has clear boundaries. If images in a multiple-choice display have different grades of clarity, the viewer is likely to have a larger pupil dilation on the most blurred image such that the pupil response would not be balanced among images within the list, resulting in pupillary responses due to non-cognitive factors that would mask the analysis of TERPs.

Scene Context:

The background or context has an impact on accuracy of identification of objects. If participants are shown images with targets in a typical context, then it is easier to identify them, compared to when they are presented without context. Disproportionate looking may be evoked when the context of images within a display is not controlled. For example, if some objects in the visual stimuli list are shown in isolation while others are shown within a scene context, the distribution of pupillary response is not likely to be balanced among the isolated objects and the images with scene contexts. Likewise, if one object is displayed in an unusual or inappropriate context, the viewer might need more time to identify the object accurately and a disproportionate effect on the pupillary responses might occur as well.

Imageability:

“Imageability” refers to the ease and accuracy by which a semantic idea is conveyed by a visual stimulus. It corresponds to the notion of abstractness versus concreteness of a depicted concept. If one or more of the target images within a display are not “imageable”, this may influence where a person looks within a display. For example, it is harder to represent the abstract concept of “angry” than to represent the concept “flower” or “ball”; the image for “angry” may disproportionately attract a viewer's attention when shown along with images of a flower and a ball. The imageability of concepts is said to underlie the finding that objects are recognized faster and at higher rates than actions when controlling for physical stimulus features. The authors' interpretation for these results is that stationary objects, such as a chair or lamp, are easier to distinguish from one another, whereas actions look similar. This factor can be used to distinguish the difficulty levels of the words and/or sentences.

Concept Frequency:

Concept frequency is a construct representing the frequency with which an individual encounters a particular concept in everyday life. The construct parallels in the cognitive domain what word frequency represents in the linguistic domain. The ease or difficulty in processing a word is reflected in the pupillary response on this word while reading. The pupillary response depends not only on the number of syllables in a word but also on the word's predictability. Compared to high-frequency words, low-frequency words tend to elicit a higher pupillary response—larger pupil diameter. Although word frequency and concept frequency are not identical, objects representing concepts that correspond to low and high-frequency words shown together within a display are likely to cause disproportional pupillary responses.

### EXAMPLES

The present invention is further illustrated by the following examples which are illustrative of some embodiments of the invention and are not intended to limit the scope of the invention in any way:

### Example 1

The purposes of this example were (1) to develop and test a method for indexing pupillometric responses to differences in word difficulty for participants with and without aphasia; (2) determine whether or not the degree of effort that participants with aphasia exhibit for easy versus difficult words is associated with the severity of their comprehension deficits and/or overall aphasia.

To examine differences during the processing of easy versus difficult words, two groups of participants were tested: a control group of adults without neurological impairments, and a group of PWA. The following research questions were addressed:

Are there significant differences in pupillary response corresponding to the presence or absence of aphasia?

In people with and without aphasia, are there significant differences in pupillary response corresponding to the difficulty of the verbal stimulus items?

Are there significant differences in pupillary response corresponding to the overall severity of aphasia, and/or specifically to the severity of auditory comprehension deficits?

Participants—General Inclusion Criteria:

A total of 85 participants were recruited (44 control participants without neurological disorders and 41 PWA). An initial case history interview was conducted on all participants to ensure that they were acceptable. The inclusion criteria included American English as a native language, no history of learning/development disorder, no history of traumatic brain injury prior to development of aphasia, and no knowledge of the purpose of the study.

All participants were given hearing, vision, and pupillary screenings prior to their participation. All participants not wearing hearing aids passed the hearing screening at 65 dB or better in left and right ears for pure-tones presented via headphones at 500-, 1000-, and 2000-Hz, and for conversational speech at 65 dB or better via headphones. Two control participants wore hearing aids during the study, and passed their hearing screening by providing two correct responses for repeating sample verbal stimulus words when presented at 65 dB SLP via sound found. Three control participants and three PWA reported having hearing aids, but chose not to wear them during the study.

Visual acuity for near vision was assessed using the 20/250 line of the Patti Pics Logarithmic Visual Acuity Chart (Precision Vision, 2003) with or without the use of glasses or contact lenses. All control participants passed the visual screening; one PWA failed. Participants were not excluded based on the results of the vision screenings; however, any deviance from normal was documented. Visual fields were examined by having each participant identify the number of fingers being held in each of the four quadrants of the visual field while maintaining gaze on the examiner's face. Three control participants missed the top right quadrant; one PWA missed the top right quadrant; two PWAs missed the lower right quadrant; three PWAs had a right field cut; and one PWA has a left field cut.

All participants underwent a pupillary examination. Information from the examination was not used as one of the inclusion criteria; however, any deviance from normal was documented. Pupil reactivity to light was examined by shining a low-beam flashlight inward from the outward corner of each eye. Normally, direct and consensual responses were present and brisk. Pupils for all control participants were judged to be within normal limits. Four PWAs had very small pupils; and three PWAs had minimal consensual constriction. In addition, any medications taken regularly by the participants were recorded so as to examine for possible effects on pupillary movement post hoc.

Control Participants

Inclusion criteria specific to control participants included these two factors: (a) no reported history of speech, language, or cognitive impairment; and (b) performance within the normal range on the Mini-Mental Status Examination (MMSE; Folstein, Folstein, & McHugh, 1975).

Control participants were recruited from Athens Ohio via flyers, mail, web-based announcements, and word of mouth. A total of 44 control participants were recruited. Five to six participants per each of the 10-year age range from 21 to 89 were recruited. Four were unable to complete the study: two had pupils that were too small to track or study; two had problems that impeded calibration (one had cataracts, and one had severe eyelid ptosis). The remaining 40 control participants completed all of the components of the hearing, vision and pupillary screenings, and were able to complete all experimental tasks. All 40 control participants scored above the 24-point impairment cut-off on the MMSE. Their scores ranged from 27 to 30 (M=29.4, SD=0.87). The ages of the control participants ranged from 23 to 88 (M=52.68, SD=19.51); their years of education ranged from 12 to 23 years (M=17.25, SD=3.02). 16 male and 24 female control participants took part in this experiment.

Participants with Aphasia (PWA)

Inclusion criteria specific to PWA included three factors: (1) diagnosis of aphasia due to stroke based on a referral from a neurologist or a speech-language pathologist, which was confirmed via neuroimaging data; (2) no reported history of speech, language, or cognitive impairment prior to aphasia onset; and (3) post-onset time of at least 2 months to ensure reliability of testing results through traditional and experimental means. Only participants who had aphasia following a cortical stroke were recruited. Any subcortical lesions were recorded.

In addition to all screening listed above for general participants, PWAs were asked to complete two visual attention screening tasks: a line bisection task and Albert's Test. In the line bisection task, participants were asked to draw a line that divided the given line into two, roughly equal portions. Albert's Test required participants to cross off each of 40 lines arranged in an array. All PWAs passed the line bisection task. The majority of PWAs crossed off all 40 lines in Albert's Test, with eight PWAs missed one out of 40 lines and one PWA missed 12 out of 40 lines.

PWAs were also administered the Aphasia Quotient (AQ) components of the Western Aphasia Battery-Revised (WAB-R, Kertesz, 2007). The AQ portion of the WAB-R consists of the following subtests: Spontaneous Speech, Yes/No Questions, Auditory Words Recognition, Sequential Commands, Repetition, Object Naming, Word Fluency, Sentence Completion, and Responsive Speech. The results from this AQ portion of the WAB-R, along with that of the Auditory Verbal Comprehension portion (which consists of the Yes/NO Questions, Auditory Word Recognition, and Sequential Commands subtests) were used for the analysis of the results for PWAs.

PWAs were recruited through mailings to local skilled nursing facilities, hospitals, neurologists, and speech-language pathologists, as well as from members of the Stroke Comeback Center in Vienna, Va. A total of 41 PWAs were recruited. Data from three participants were unusable: one had pupils that were too small to track; one had cataracts that impeded calibration; and one had data collected only from the experimental condition due to technical difficulties. The remaining 38 participants completed all of the components of the hearing, vision, and pupillary screenings, and were able to complete all experimental tasks. Ages of PWAs ranged from 24 to 82 (M=56.11, SD=13.12). Years of education ranged from 12 to 23 years (M=16.61, SD=3.23). Twenty-four male and fourteen female PWAs participated in the experiment. There were no significant differences in ages or years of education between the control participants and PWAs (age: t(68.55)=−0.92, p=0.36, 95% CI [−10.91, 4.05]; education: t (76)=0.91, p=0.37, 95% CI [−0.76, 2.05]).

According to the severity scores on the AQ of the WAB-R, twenty-three PWAs were classified as mild (AQ ranged from 76 to 100), ten PWAs were classified as moderate (AQ ranged from 50 to 75), and five PWAs as severe (AQ ranged from 26 to 50). Twenty-one PWAs were classified as having anomic aphasia, five PWAs as having conduction aphasia, and nine PWAs as having Broca's aphasia. One PWA was classified as having either Broca's aphasia or transcortical motor aphasia, and two PWAs were classified as having conduction or anomic aphasia.

Instrumentation

A Maico MA25 Audiometer (Maico Diagnostics) was used to screen participants' hearing. Boston Media Theater speakers (Boston Acoustics, Inc.) were used to present auditory stimuli and sound-field hearing screening stimuli. An Eyefollower 2.0 Eyegaze System (LC Technologies) was used to monitor participants' eyes and to measure and record pupillary movements. The Eyefollower 2.0 Eyegaze system measured participants' gaze points at a rate of 120 Hz, and generated pupil diameter for each camera image sample for both eyes (LC Technologies, Inc., 1009). Custom software was used to derive all pupillometric measures from the raw data collected.

Luminance of all visual stimuli was measured using a Gossen Starlite 2 light meter.

Stimuli—Stimulus Selection

Stimulus words (nouns) were selected from the Snodgrass and Vanderwart (1980) word set. Visual stimuli were selected from the Rossion and Pourtois (2004) image set. These images, based on images from the original Snodgrass and Vanderwart (1980) image set, were selected because computerized images were available, which allowed for manipulation of the images to reduce differences in luminance. Words were selected based on estimated difficulty such that each fit clearly into one of two categories: easy or difficult.

Combinations of four types of measures that have been used to approximate word difficulty were used: age-of-acquisition estimates, word frequency measurements, word familiarity estimates, and naming latency measurements.

Previous studies have shown that estimated age-of-acquisition is the chief determinant of naming latency (Carroll & White, 1973a, 1973b). Carroll and White (1973) evaluated age-of-acquisition of 220 images by asking participants to estimate when they had first learned a word and its meaning in either spoken or written form. Participants were given the following 1-9 point scale: (1) Prenursery (age 2); (2) Prenursery (age 3); (3) Nursery (age 4); (4) Kindergarden (age 5); (5) First Grade (age 6); (6) Second, Third Grade (Ages 7-8); (7) Fourth, Fifth Grade (ages 9-10); (8) Sixth, Seventh Grade (ages 11-12), and (9) Eighth Grade and above (ages 13+). Words that were judged to have been learned earlier by participants were named faster than those words that were judged to have been learned later. Snodgrass and Vanderwart (1980) found that Carroll & White's (1973a) age of acquisition estimates correlated highly with rated familiarity for the 87 images in their experiments. The current study used the 1996 estimate of Snodgrass and Yuditsky for age of acquisition for 250 images in the Snodgrass and Vanderwart (1980) word set.

Word frequency has been shown to correlate highly with word difficulty. Breland (1996) compared word frequency measurements from four different collections of text to word difficulty estimates established by Dupuy (1974). Dupuy's difficulty estimates were obtained through the development of a Basic Word Vocabulary Test with ten levels of difficulty; this multiple-choice vocabulary test was administered to students in grades 1-12. The 123 words, which were chosen randomly form Webster's Third New International Dictionary, were assigned difficulty ranks based on the percentage of participants who had answered each item correctly (Dupuy, 1974). The correlations between the word difficulty estimate and the word frequency indices were high. The theory about word frequency as it relates to word difficulty is that difficult words will appear less often, and words that are more commonly encountered will be learned faster and remembered better. Word frequency measurements for the current study were taken from Kucera and Francis frequency norms (Kucera & Francis, 1967).

Familiarity ratings were taken from Snodgrass and Vanderwart (1980). In Snodgrass and Vanderwart's study, they instructed participants to give familiarity ratings to 260 picture stimuli, the familiarity rating being “the degree to which you come in contact with or think about the concept” (p. 183). Participants were asked to rate the images on a 5-point scale, with a rating of 1 indicating very unfamiliar and 5 indicating very familiar. Results suggested that the familiarity rating was positively correlated with frequency and negatively correlated with age-of-acquisition ratings. Therefore, words that are more familiar typically occur more frequently and are learned at an earlier age.

Naming latency ratings was taken from Snodgrass and Yuditsky (1996). The assumption for the rating based on findings form previous researches is that more difficult words result in longer naming latencies than easier words.

In each of the four categories—familiarity ratings, frequency counts, age-of-acquisition estimates, and naming latencies, the rating of each word in this study was compared to the mean for each category. Only the words that were either greater than one standard deviation above or below the mean in each of four categories were selected initially to ensure a substantial gap exists between “easy” and “difficult” words. That is, words that fell within one standard deviation of the mean in each category were not selected.

Words that were greater than one standard deviation above the mean for familiarity rating were considered “easy”; words that were greater than one standard deviation below the mean were considered “difficult.” Words that were greater than one standard deviation above the mean for frequency estimate were considered “easy”; words that had a frequency rating of zero or one were considered “difficult.” For the category of frequency estimate, due to the rating value and the relationship between the mean and standard deviation of the sample, it is not possible to obtain words one full standard deviation below the mean. Words that were greater than one standard deviation above the mean for age-of-acquisition estimates were considered “difficult”; words that were greater than one standard deviation below the mean were considered “easy.” Words that were greater than one standard deviation above the mean for naming latencies were considered “difficult”; words that were greater than one standard deviation below the mean were considered “easy.”

During the final selection, words that were classified as “easy or “difficult” according to at least two out of four categories were considered. Then the two lists—“easy” and “difficult” were made equivalent based on the number of syllables in words for each list. A total of thirty words were chosen for the final selection, fifteen in the “easy” category and fifteen in the “difficult” category. An additional three words were chosen for each category to be used in foil trials, bringing the total number of word stimuli presented during the baseline and experimental tasks to 36 words.

Stimulus Development—Auditory Stimuli

Auditory stimuli were recorded by an adult male native speaker of American English. Recording took place in a sound-proof booth using a high-quality microphone directly connected to a PC. The speaker recorded each word several times in uninterrupted strings. The token (specific spoken record for a word) with best quality in terms of articulation and word-level stress was later selected by unanimous votes of three listeners. Each verbal stimulus was then digitized (22 kHz, low-pass filtered at 10.5 kHz), normalized for intensity to zero dB, and stored on the computer using Adobe Audition 2.0® (2006).

Stimulus Development—Visual Stimuli

Color images from Rossion and Pourtois (2004) were chosen to match selected words. First, color images were individually converted to black-and-white images using Adobe Photoshop CS3 Extended® (2007). Specifically, each image was imported into Photoshop, and then converted into monochrome using the channel mixer: Individual source channels (red, green, and blue) were altered to produce an image that was as close as possible to a line drawing, for example, shadings were minimized as much as possible without degrading image quality. Secondly, using the GNU Image Manipulation Program 2.6® (2010), the PIC images generated in the first step were imported and layered onto a standard sized, white background, and then saved as JPEG images. This step was done to prevent image distortion once the images were displayed during the study.

Luminance, a measure of light emitted from a source, of all images was measured using the Gossen Starlight 2 light meter in order to account for possible effects of light on pupil diameter. The luminance values of the images ranged from 188.8 cd/m² to 266 cd/m² (M=245.2 cd/m², SD=17.4 cd/m²). Sixty-six percent (24/36) of the images' luminance was within one standard deviation of the mean. One image's luminance was greater than two standard deviations below the mean.

Foil Stimuli

Twenty percent of trials were foil trials in which the visual and auditory stimuli did not match. For example, participants heard the word “dog” but saw a spoon instead of seeing the corresponding “dog” image. These foils were inserted to add an unexpected element to the experimental condition. This was intended to help prevent boredom and ensure that the participants maintained their attention throughout the experiment.

The six foil words corresponding to auditory stimuli were arranged alphabetically and each assigned a number from 1 to 6. A random number table was used to assign the numbers 1 to 6 to the visual stimuli. For example, the word “artichoke” was assigned the number 1 for the auditory stimuli. The first number in the random number table was the number 4, which corresponded to the word “artichoke” in the original list. Therefore, the auditory stimulus “artichoke” was paired with the image “leaf” for that particular foil trial.

Filler Image

In order to prevent pupillary changes due to an abrupt change in luminance between trials, a filler image consisting of six circles was inserted between each trial image in both baseline and experimental conditions. This image was displayed for three seconds, and it was not accompanied by an auditory stimulus.

### Procedure

Each participant (control and PWA) underwent the baseline condition and then the experimental condition. Participants were allowed to take breaks between tasks as needed. Participants sat in a comfortable, high-backed chair and were offered the use of a chin rest in order to aid in head stabilization. Thirty-one control participants chose to use the chin rest; nine control participants did not. No PWA chose to use the chin rest. Each participant was positioned so that his/her head was 24-26 inches from the computer screen during each task in order to prevent the accommodation reflex, which might result in bilateral constriction of the pupils in response to images within 4 to 6 inches of an participant's nose.

Baseline Condition

Baseline measures of pupil diameter were obtained prior to the initiation of experimental trials. During this condition, the participants were exposed to all visual stimuli (both experimental and foil) used in the rest of the experimental condition without any accompanying verbal stimuli. A random order of presentation of experimental and foil stimuli was determined using a random number table (www.stattrek.com).

The participants were instructed to “look at the pictures in any way that comes naturally.” An additional prompt indicating that this task did not include any “sounds” was provided in order to assure participants that they were simply to look at the images on the screen. For example, the prompt might say “Remember, there will be no sounds during this task. Just look at the images.” Each image was then displayed for three seconds, during which pupillary data were collected. Mean pupil diameter, maximum pupil diameter, and latency of maximum pupil diameter were determined for each participant in each trial. These points were used to determine the relative amount of pupil dilation, rather than absolute pupil diameter, observed during the experimental condition.

Experimental Condition

During the experimental condition, visual and auditory stimulus items were presented simultaneously. Items were presented in a different random order than they were in the baseline condition. This task administered via headphones at approximately 65 dB as assessed by a sound level meter. For participants with hearing aids, the task was presented via computer speakers at approximately 70 dB as assessed by a sound level meter. The participants were instructed to “Listen to the words and look at the pictures.” The participants were given three seconds to view the image before the computer automatically advanced to the next item. Task-evoked pupillary responses (TERPs) have been shown to occur within 100-200 milliseconds following the onset of processing, and subside quickly following the termination of processing. Three seconds of viewing time allowed a sufficient time frame to observe any pupillary changes. By providing the participants ample time, any differences between control participants and PWAs might be clearly observed.

FIG. 5 shows a sample experimental stimulus—an image of a banana; and this image was presented on the computer screen simultaneously with the auditory pronunciations of the word “banana.” FIG. 2 shows a sample foil stimulus—image of an artichoke; and this image was presented simultaneously with the auditory pronunciation of the word “artichoke.” FIG. 3 shows filler stimulus; the image was displayed for three seconds between each experimental stimulus item.

Sorting Task

Following the completion of the baseline and experimental pupillometric tests or conditions, each participant was asked to perform a sorting task. The participants were given a stack of cards, each of which included an image on one side and the corresponding printed word for each verbal stimulus used in the experiment on the other side. The participants were asked to sort each card into one of two piles, easy or difficult. No definition of “difficult” was provided so that each participant could form his or her own operational definition. However, some participants required some instruction on the distinction between “easy” versus “difficult” because the words in the list were relatively easy for these participants. These participants (the ones needing instructions) were instructed to think of the relative difficulty of the words by evaluating whether the words were “relevant to this set of words only.” Upon completion of the sorting task, the clinician asked the participants “did you find yourself using any specific strategy/strategies to divide the cards into “easy” and “difficult” piles?” Any strategy stated was recorded for the individual participant. Sorting tasks were intended to validate the stimulus selection method as well as to provide individual bases for comparing pupillometric results to perceived word difficulty.

Specific Hypothesis Tested in this Example:

1. When viewing a single image presented simultaneously with an auditory stimulus, the participants with and without aphasia will exhibit differences in pupillary response.

2. When viewing a single image presented simultaneously with an auditory stimulus, the pupillary responses of PWA will be correlated with the severity of their aphasia as indexed by the WAB AQ and Auditory Comprehension (AC) score.

3. When viewing a single image presented simultaneously with an auditory stimulus, pupillary responses will be correlated with each of the five measures of word “difficulty” (as indexed by age-of-acquisition estimates, word frequency measurements, word familiarity estimates, naming latency measurements, and perceived difficulty).

Dependent Measures

One type of dependent measures is the method of measuring or evaluating the pupil dilation as related to cognitive processing. The magnitude of pupil dilation is linked to intensity and effort involved in cognitive processing. Further, the simple maximum pupil diameter could be correlated to the time period immediately prior to a participant's response to a task. There are two known ways of measuring and evaluating the magnitude of pupil dilation. One way is by obtaining a simple maximum measure, such as the single highest amount of dilation observed during a set time period. The other way is by calculating a mean or average pupil dilation over a response interval. In this study, both types of measurements were obtained, in addition to which the latency of the simple maximum measurement of pupil diameter was also evaluated.

The other dependent measures are presence or absence of aphasia, the severity of aphasia, and the difficulty level of the stimulus items. These measures may influence (a) the intensity of processing required to complete a task, which may be reflected in the magnitude of pupil dilation; and/or (b) the time frame required to complete the task, which may be reflected in the latency of the simple maximum pupil diameter. If these pupillometric measurements can reliably differentiate between any of the above conditions (i.e., PWA versus controls, mild versus severe aphasia, easy versus difficult words), they can be used in future comprehension testing protocols that do not require overt verbal or physical responses from the participants.

In each condition (baseline or experimental), measurements were taken in relation to four events: (1) the onset of the visual stimulus; (2) the onset of the auditory stimulus; (3) the offset of the auditory stimulus; and (4) the offset of the visual stimulus.

Table 1 shows three calculation methods of pupil diameters, using the onset of the visual stimulus as the starting point for the measurement.

TABLE 1
Calculation Methods of Dependent
Measures

| Dependent Measure | Calculation |
|---|---|
| Maximum pupil diameter | Subtracting the single maximum pupil |
| (in mm) | diameter obtained in each task during the |
| | baseline condition from the single |
| | maximum pupil diameter obtained in each |
| | task during the experimental condition. |
| Latency of maximum pupil | Subtracting the number of milliseconds |
| diameter (in msecs) | following the onset of the visual stimulus |
| | when the single maximum pupil diameter |
| | occurred in the baseline condition from |
| | same measure in the experimental |
| | condition |
| Mean Pupil Diameter | Subtracting the mean pupil diameter in |
| | each task during the baseline condition |
| | from the mean obtained in the |
| | experimental condition. |

### Results

A. Comparison of Pupillometric Responses of People with and without Aphasia

Separate, two-way repeated measurements of ANOVAs were computed to examine the interaction between group (control vs. PWA) and item difficult on each dependent variable, namely maximum pupil diameter, latency of maximum pupil diameter, and mean pupil diameter.

With regard to mean pupil diameter, the results in Tables 2 and 3 show that the mean pupil diameter was significantly changed for difficult items as compared to easy items (F(1,66)=60.85, P<0.001). Mean pupil diameter was significantly smaller for easy words (M=−0.02) than for difficult words (M=0.05). No significant effect was found between the control and PWA groups. The interaction between the difficulty and group was found not be significant (F(1, 66)=1.5, p>0.05).

Tables 2 and 3 display descriptive statistics and ANOVA results respectively.

TABLE 2
Descriptive Statistics for Hypothesis #1

| | | | Measure Type | | |
|---|---|---|---|---|---|
| | | | Diameter Measures | | Latency Measures |
| | | | (mm) | | (ms) |
| Participants | Condition | | Max | Mean | Latency |
| Control | Easy | N | 33 | 33 | 33 |
| participants | | M | 0.01 | −0.02 | −0.05 |
| | | SD | 0.28 | 0.08 | 0.39 |
| | Difficult | N | 35 | 35 | 35 |
| | | M | 0.10 | 0.07 | −0.05 |
| | | SD | 0.35 | 0.08 | 0.33 |
| PWA | Easy | N | 38 | 38 | 38 |
| | | M | −0.10 | −0.02 | −0.07 |
| | | SD | 0.32 | 0.07 | 0.33 |
| | Difficult | N | 36 | 36 | 36 |
| | | M | −0.07 | 0.03 | −0.05 |
| | | SD | 0.52 | 0.08 | 0.42 |

Note.
Max = maximum pupil diameter;
Latency = latency of maximum pupil diameter.

TABLE 3
Repeated Measures ANOVA for Control Participants and PWA

| Measure type | Measure | Source | df | MS | F | P | η² |
|---|---|---|---|---|---|---|---|
| Diameter | Max | Group | 1.66 | 0.66 | 3.19 | 0.08 | 0.05 |
| measures | | Difficulty | 1.66 | 0.11 | 1.13 | 0.29 | 0.02 |
| | | Difficulty * Group | 1.66 | 0.03 | 0.36 | 0.55 | 0.01 |
| | Mean | Group | 1.66 | 0.006 | 0.65 | 0.42 | 0.01 |
| | | Difficulty | 1.66 | 0.16 | 60.85 | 0.000 | 0.47 |
| | | Difficulty * Group | 1.66 | 0.004 | 1.51 | 0.22 | 0.01 |
| Latency | Latency | Group | 1.66 | 0.006 | 0.04 | 0.85 | 0.00 |
| measures | | Difficulty | 1.66 | 0.00 | 0.003 | 0.95 | 0.00 |
| | | Difficulty * Group | 1.66 | 0.002 | 0.02 | 0.88 | 0.00 |

Note.
Max = maximum pupil diameter;
Latency = latency of maximum pupil diameter.

B. Relationship Between Severity of Aphasia and Comprehension Deficits to Pupillometric Responses

A Pearson product-moment correlation coefficient (shown in Table 4) was computed to assess the relationship among severity of aphasia (as determined by WAB-R aphasia Quotient (AQ) scores), severity of comprehension deficit (as indexed by WAB-R Auditory Comprehension (AC) scores), and individual responses. The coefficient data are summarized in Table 4.

The data in Table 4 show that there was a significant negative correlation between PWA scores on the WAB-R AC and the latency of maximum pupil diameter for easy words, r(38)=−0.40, p=0.014. The remaining comparisons show no significant differences.

TABLE 4
Correlations of the Severity of Aphasia and Severity of Comprehension
Deficits with Pupillary Responses for PWA

| Measure | Pupillary | Severity scores | |
|---|---|---|---|
| Type | responses | WAB AQ | WAB AC |
| Diameter | Max - Easy | r(38) = −0.19, p = 0.26 | r(38) = −0.23, |
| measures | | | p = 0.17 |
| | Max - Hard | r(36) = 0.25, p = 0.14 | r(36) = 0.12, |
| | | | p = 0.47 |
| | Mean - Easy | r(38) = −0.24, p = 0.15 | r(38) = −0.21, |
| | | | p = 0.20 |
| | Mean - Hard | r(36) = −0.21, p = 0.21 | r(36) = −0.20, |
| | | | p = 0.24 |
| Latency | Latency - Easy | r(38) = −0.26, p = 0.12 | r(38) = −0.40*, |
| Measures | | | p = 0.01 |
| | Latency - Hard | r(36) = 0.10, p = 0.55 | r(36) = −0.01, |
| | | | p = 0.98 |

Note.
WAB AQ = Aphasia Quotient from the Western Aphasia Battery - Revised;
WAB AC = Auditory Verbal Comprehension sections of the Western Aphasia Battery - Revised;
Max - easy = maximum measure for easy words;
Max-hard = maximum measure for hard words;
Mean - Easy = mean pupil diameter for easy words;
Mean - Hard = mean pupil diameter for hard words;
Latency - Easy = latency of maximum diameter for easy words;
Latency - Hard = latency of maximum diameter for hard words.

C. Relationships Between Five Measures of Word Difficulty and Pupillometric Responses in People with and without Aphasia

A Pearson product-moment correlation coefficient was computed to examine the relationship between participant pupillary responses and the five measures of word difficulty used to assign “easy” or “difficult” status to stimuli: familiarity, frequency, age of acquisition, naming latency and perceived difficulty. Perceived difficulty is determined by the participants in the sorting task after the completion of the experimental conditions. Correlations were run separately for the control participants and the PWAs. The results are summarized in Tables 5 and 6.

TABLE 5
Correlations between Measures of Word Difficulty and Pupillary
Responses for Control Participants

| | Pupillary responses | | |
|---|---|---|---|
| Measures of | Diameter measures | | Latency Measures |
| word difficulty | Max | Mean | Latency |
| Familiarity | r(30) = −0.17 | r(30) = −0.26 | r(30) = −0.003 |
| | p = 0.38 | p = 0.17 | p = 0.99 |
| Frequency | r(30) = −0.04 | r(30) = −0.13 | r(30) = −0.10 |
| | p = 0.83 | p = 0.51 | p = 0.59 |
| Age of Acquisition | r(30) = 0.26 | r(30) = 0.44* | r(30) = −0.05 |
| | p = 0.17 | p = 0.02 | p = 0.80 |
| Naming Latency | r(30) = 0.11 | r(30) = 0.35 | r(30) = 0.16 |
| | p = 0.55 | p = 0.06 | p = 0.39 |
| Perceived difficulty | r(30) = 0.27 | r(30) = 0.14 | r(30) = 0.000 |
| | p = 0.15 | p = 0.47 | p = 0.10 |

Correlation is significant at the 0.05 level (2-tailed).
Note.
Max = maximum pupil diameter;
Latency = latency of maximum pupil diameter

TABLE 6
Correlations between Measures of Word Difficulty and
Pupillary Responses for PWA

| | Pupillary responses | | |
|---|---|---|---|
| Measures of | Diameter measures | | Latency Measures |
| word difficulty | Max | Mean | Latency |
| Familiarity | r(30) = 0.15 | r(30) = −0.25 | r(30) = 0.08 |
| | p = 0.44 | p = 0.18 | p = 0.68 |
| Frequency | r(30) = −0.03 | r(30) = −0.10 | r(30) = 0.08 |
| | p = 0.88 | p = 0.60 | p = 0.67 |
| Age of Acquisition | r(30) = 0.04 | r(30) = 0.44* | r(30) = 0.06 |
| | p = 0.84 | p = 0.03 | p = 0.77 |
| Naming Latency | r(30) = −0.10 | r(30) = 0.41* | r(30) = 0.03 |
| | p = 0.60 | p = 0.03 | p = 0.87 |
| Perceived difficulty | r(30) = −0.30 | r(30) = 0.11 | r(30) = −0.06 |
| | p = 0.41 | p = 0.56 | p = 0.76 |

*Correlation is significant at the 0.05 level (2-tailed).
Note.
Max = maximum pupil diameter;
Latency = latency of maximum pupil diameter

The results in Tables 5 and 6 show that there was a positive correlation between the age of acquisition and the mean pupil diameter (r(30)=0.44, p=0.02) for the control participants. For PWAs, there was a positive correlation between the mean pupil diameter and two measures: (1) age of acquisition (r(30)=0.40, p=0.03); (2) naming latency (r(30)=0.41, p=0.023). Data show no significant correlation between other measures and pupil responses.

### Discussion

A. Comparison of Pupillometric Responses of People with and without Aphasia

The results show that mean pupil diameters changed significantly in relation to difficulty of words—mean pupil diameter was significantly smaller for easy words than for difficult words. These findings may suggest that for participants as a whole, the intensity of cognitive effort was less for easy words than for difficult words.

B. Relationship Between Severity of Aphasia and Comprehension Deficit as Evaluated by Pupillometric Responses (Hypothesis #2)

It is theorized that maximum pupil dilation indicated the point at which a participant's processing is at a high intensity level, often immediately prior to solution or completion of a task. The results show that PWA scores on the WAB-R AC are negatively correlated to the latency of maximum pupil diameter for easy words. No other significant correlation was found. The higher a PWA score on the Auditory Verbal Comprehension portion of the WAB-R, the less a severe comprehension deficit the PWA has. The negative correlation between this score and the latency of maximum pupil diameter suggests that PWAs having less severe comprehension deficit take less time to reach maximum pupil dilation in the trials involving “easy” stimuli. Thus, this result indicates that PWAs with less severe auditory comprehension deficits process easy words more quickly than difficult words, whereas PWAs with more severe auditory comprehension deficits did not show a preference.

It is important to note that the Bonferroni correction was not utilized for analysis of this hypothesis and that of the following hypothesis. The use of the correction might have rendered these results insignificant. The correction was not used in order to increase the likelihood of detecting any potential significance, which could possibly guide the future directions of this method.

The lack of any other significant correlations suggests that the experimental parameters may need to be adjusted, including the tasks, in order to index or examine subtle differences in the language abilities of the participants. Both the task and the methods could be modified or improved in future researches.

C. Relationships Between Measures of Word Difficulty and Pupillometric Responses in People with and without Aphasia (Hypothesis #3)

For control participants, the results show that they exhibited higher mean pupil diameters as the age of acquisition of the word increased. The correlation suggests that the later a word is learned, the greater amount of effort is required for the processing of that word. The results are logical: age acquisition is a chief determinant in naming latency, and the age of acquisition was shown to be negatively correlated with word familiarity in other studies. In other words, as the age of acquisition increases for a word, the naming latency increases and the word is judged to be less familiar, indicating that a greater amount of effort is required for the processing of the word. Interestingly, there is no significant correlation between pupil responses and the naming latency for the control participants.

For PWAs, the results show that (1) age of acquisition and mean pupil diameter were positively correlated; and (2) naming latency was also positively correlated with the overall mean pupil diameter. Given that age of acquisition is a main factor in influencing the naming latency, the fact that these two correlations were shown to be significant is not surprising. However, it is important to note that PWAs have significant correlation between mean pupil diameter and two measures of word difficulty whereas control participants had only one significant correlation. This difference between PWAs and control participants may indicate that PWAs possess an increased sensitivity to difficult linguistic stimuli. These correlations also provide a greater insight into which one or more measures have the best potential for determining word difficulty in the future, especially for participants with neurological impairments.

Method of Analysis—Analysis without Baseline Data

In an effort to determine the most sensitive way to analyze data for this novel method, all analyses were repeated not including baseline data. In the analysis above, in order for each participant to serve as his/her own control to minimize potential differences of the general peripheral system, pupillary responses were obtained after subtracting the participants' pupillary responses obtained during the baseline tasks (see Table 1).

Previous literature is divided between studies that incorporate this type of baseline correction into analysis and those that use alternate methods of accounting for baseline pupil diameter. Other methods include simply reporting the absolute pupil diameter, comparing absolute diameters during a baseline to absolute diameters during the experimental condition, measuring the amount of dilation following a baseline condition at the beginning of each trial, reporting change as a percentage, and other type of more complicated analysis. Therefore, to evaluate whether or not any subtle difference or significant correlations were obscured by the baseline correction, the same analyses discussed above for each hypothesis were repeated by using absolute pupil diameters. The significant findings based on the analyses are discussed below.

A. Comparison of Pupillometric Responses of People with and without Aphasia (Hypothesis #1)

A significant difference was found between the control group and PWAs for maximum pupil diameter (F(1, 69)=7.00, p=0.01): Maximum pupil diameter was significantly smaller for control participants (M=3.12) than for PWAs (M=3.41).

Further, significant correlations where found between the word difficulty level and each measure of pupil responses: Maximum pupil diameter was significantly smaller for easy words (M=3.23) than for difficult words (M=3.30), F(1,69)=7.49, p=0.008. Latency of maximum pupil diameter was significantly shorter for easy words (M=1.34) than for difficult words (M=1.45), F(1,69)=11.61, p=0.001. Mean pupil diameter were significantly smaller for easy words (M=2.84) than for difficult words (M=2.88), F(1, 69)=57.89, p<0.001.

B. Relationship Between Severity of Aphasia and Comprehension Deficit as Evaluated by Pupillometric Responses (Hypothesis #2)

There were two significant negative correlations: one is between PWA scores on the WAB-R AQ and the average maximum pupil diameter for easy words (r(38)=−0.32, p=0.05); the other is between PWA scores on the WAB-R AC and the average maximum pupil diameter for easy words (r(38)=−0.40, p=0.01).

C. Relationships Between Measures of Word Difficulty and Pupillometric Responses in People with and without Aphasia (Hypothesis #3)

For control participants, there was a significant negative correlation between the frequency and the average latency of the maximum pupil diameter (r(30)=−0.37, p=0.05.

For PWAs, there was a significant positive correlation between the age of acquisition and the average mean pupil diameter (r(30)=0.41, p=0.03).

Differences Between the Method Subtract Baseline Data and the Method not Subtract Baseline Data

As analyzed above, the analysis of variables not incorporating baseline values yielded more significant results than the analysis of variables incorporating baseline values. Tables 7, 8 and 9 display significant differences between the results of two methods of analysis for each hypothesis.

TABLE 7
Comparison of Significant Results for Hypothesis #1

| | Significant with | Significant |
|---|---|---|
| Measure/comparison | baseline | without baseline |
| Max-group | | * |
| Max-difficulty | | * |
| Max-difficulty*group | | |
| Mean-group | | |
| Mean-difficulty | * | * |
| Mean-difficulty*group | | |
| LatMax-group | | |
| LatMax-difficulty | | * |
| LatMax-difficulty*group | | |

TABLE 8
Comparison of Significant Results for Hypothesis #2

| | |
|---|---|
| Significant with | Significant without |
| baseline | baseline |

| Measure | AQ | AC | AQ | AC |
|---|---|---|---|---|
| Max-easy | | | * | * |
| Max-hard | | | | |
| Mean-easy | | | | |
| Mean-hard | | | | |
| LatMax-easy | | * | | |
| LatMax-hard | | | | |

TABLE 9
Comparison of Significant Results for Hypothesis #3

| Group/ | Significant with baseline | | | | | Significant without baseline | | | | |
|---|---|---|---|---|---|---|---|---|---|---|
| Meas | Fam | Freq | AoA | Nam Lat | PD | Fam | Freq | AoA | Nam Lat | PD |
| C Max | | | | | | | | | | |
| C Mean | | | * | | | | | | | |
| C Lat | | | | | | | * | | | |
| Max | | | | | | | | | | |
| PWA | | | | | | | | | | |
| Max | | | | | | | | | | |
| PWA | | | * | * | | | | * | | |
| Mean | | | | | | | | | | |
| PWA | | | | | | | | | | |
| LatMax | | | | | | | | | | |

### Overall Discussion

The purpose of this study was to develop and test a novel method for assessment of single-word auditory comprehension abilities in participants with neurological disorders. The results of this study indicate that the present invention is able to use pupillometry to capture effects of word difficulty in participants with and without neurological impairments. The effect of difficult words was illustrated by using single nouns, all of which many participants believed to be “easy,” suggesting that the method of the present invention may be sensitive enough to capture even subtle differences in the efforts required to process generally easy stimuli. The results of the present method not only reveal differences as related to word difficulty, but also differences in the time frame required for the processing of stimuli for PWAs with varying levels of comprehension deficits.

Tasks in this study can be modified to increase the sensitivity and validity of the pupillometry method of the present invention for assessing the language comprehension for participants with neurological impairments or disorders.

First, the complexity of the visual stimuli can be reduced, or the visual stimuli may potentially be eliminated totally, which may result in increased sensitivity to TERPs. Generally, it is very difficult or considered to be non-feasible to obtain reliable pupillary responses that reflect cognitive effect while participants are engaged in a visual task. Several studies that have reported significant findings regarding pupillometry have made use of nonvisual tasks, with or without fixation points. Studies that did use visual stimuli used images far less complex than the ones in the current study, such as single letters and simple geometric shapes. In addition, it is possible that the magnitude of pupillary response is more sensitive to tasks that employ only auditory, rather than visual, stimuli.

Another aspect that can be improved is the determination of the difficult level of any particular word by using other criteria such as word length and/or pronunciation. Further, pupillary measures can be analyzed to evaluate the differences in difficulty related to sentence repetition, sentence comprehension, sentence complexity, syntactic ambiguity, and prosody.

In addition, research has shown that individuals with aphasia have difficulty with particular aspects of grammar, including argument structure of verbs, unaccusative versus unergative verbs, verb inflection, active versus passive verb, use of complementizers, use of locative prepositions, and subject- versus object-relative sentences. All of these above sentence structures can be used to vary the difficulty levels of the sentences to be used as stimuli in the present method to assess if a particular participant has any language impairment, such as aphasia.

The analysis of the pupillary response data can also be modified by using additional or different methods of analysis. For example, the pupillary response data for experimental tasks can be analyzed alone without incorporating baseline measures or values. Alternatively, in order for each participant to serve as his/her own control to minimize potential differences of the general peripheral system, pupillary response data for the experimental tasks were compared to the baseline pupil measures obtained during the baseline task (visual stimuli only). However, the use of baseline measure may obscure potential significant results, and may not be necessary in some cases.

Further, several other analysis aspects could be modified. For example, in order to examine information regarding participants' attention during different portions of the experimental task, early and/or later trials within the experimental task may be analyzed separately. This analysis can be used to check for any potential practice effect, in which participants become familiar with the properties of the stimuli or with the task itself. With increasing familiarity, the magnitude of the pupil dilation decreases. Any significant difference between earlier and later trials may be indicative of attentional decreases throughout the task, or habituation towards the stimuli or task.

Finally, the present example demonstrates that (a) pupillometric method of the present invention can index cognitive intensity/effort involved in the processing of easy and difficult single nouns, and (b) pupillometric method of the present invention can be used to evaluate the linguistic comprehension levels of individuals with neurological impairments, especially with regard to whether or not the individuals have any linguistic deficit.

### Example 2

The purpose of this example is to test procedural variations of pupillometric methods with individuals without aphasia to validate and standardize the method so that the present inventive method can reliably index cognitive effort and intensity required for processing easy and difficult verbal stimuli. Methodological aspects of the previous example, including TERP measurement and modality of stimulus presentation, will be systematically tested. The resulting method can be used for the study of effort in linguistic processing in individuals with aphasia or other neurological impairments.

The following questions will be addressed in this example:

How will different measurement techniques (i.e., absolute value, subtraction methods, and normalization methods) impact the measurement and interpretation of TERPS induced by processing of easy and difficult single nouns and sentences?

Will there be a significant difference in the amplitude of TERPs in the auditory-only vs. auditory-visual tasks involving easy and difficult single nouns and sentences?

### Methods

Participants

A total of 40 participants will be recruited form the Athens, Ohio community via flyers, mail, web-based announcements, and word-of-mouth. Participants who complete the study will be paid $10 in cash. Inclusion criteria will include: age of at least 21 years; American English as a native language; no history of learning/developmental disorders; no history of traumatic brain injury; no reported history of speech; language or cognitive impairment; no knowledge of the purpose of this study; passing a hearing screening at 500-, 1000-, and 2000-Hz pure tones at 25 dB HL via headphones, and passing visual acuity screening similar to the one conducted in Example 1.

Exclusion criteria will be bilingualism. Participants will be considered bilingual if a language other than American English is used for conversational purposes for duration of 2 hours per day or longer.

In addition, all participants will complete an initial case history interview. Visual acuity for near vision will be assessed using the 20/250 line of the Patti Pics Logorithmic Visual Acuity Chart (Precision Vision, 2003) with or without the use of glasses or contacts. Visual fields will also be examined by having participants identify the number of fingers held up in each of the four visual quadrants. Pupillary screening will be conducted for informational purposes only, which include examining pupil size and reactivity to light.

Instrumentation

A Maico MA25 audiometer (Maico Diagnostics) will be used to screen participants' hearing. Boston Media Theater speaker (Boston Acoustics, Inc.) will be used to present auditory stimuli and sound-field hearing screening stimuli. The Eyefollower 2.0 Eyegaze System (LC Technologies) will be used to monitor participants' eyes and to record pupillary responses/movements. The Eyefollower 2.0 Eyegaze system measure participants' gaze points at a rate of 120 Hz; pupil diameters will be calculated for each camera image sample for both eyes (LC Technologies, Inc., 2009). Custom software will be used to obtain and analyze all pupillary response data (also called dependent measures), such as maximum pupil diameter, average pupil diameter, and latency to maximum for each condition. A condition refers to each type of stimuli, such as easy words, difficult words etc.

Stimuli Selection and Compilation

All verbal stimuli will be classified as either “easy” or “difficult,” and they will be presented to the participants in an auditory manner (“auditory stimuli”). Auditory stimuli will consist of easy nouns, difficult nouns, easy sentences, and difficult sentences. All sentences will be syntactically and semantically reversible. In determining the difficulty levels of the auditory stimuli, linguistic concepts with a clear and robust delineation between easy and difficulty will be chosen.

Single nouns used in the auditory-visual task of the present example are taken from the list developed in Example 1. Single nouns to be used in the auditory-only task will be selected using the MRC Psycholinguistic Database (2012). The selection criteria for new nouns are substantially the same as that of Example 1: the values of the following parameter will fall more than one standard deviation of the values of the nouns for each of these factors: frequency, familiarity, age of acquisition, and imagery.

Easy and difficult sentences will consist of active and passive sentences respectively. All sentences will be syntactically and semantically reversible. The full passive form, including the use of “was” and “by,” will be used for all passive sentences in this study. Active sentences will be considered to be difficult sentences, while the passive sentences will be considered easy sentences. Easy and difficult sentence list will then be balanced for frequency, familiarity, and length in terms of number of words.

Active and passive sentences, as well as visual stimuli, will be selected, with permission from the authors, from the Verb and Sentence Test (VAST; Bastiaanse, Edwards, & Ripens, 2002) and the Eyetracking Picture Test of Auditory Comprehension (EPTAC; Hallowell, 2012). The images from both the VAST and the EPTAC have been validated to ensure that individuals interpret them to convey the linguistic construct (sentences) with which they are paired.

The key difference between active and passive sentences is the ordering of the constituents within the sentence. Active sentences, similar to many English sentences, are composed with the subject of the sentence appearing first, followed by the verb, then finally by the object of the verb. The subject-verb-object (S-V-O) ordering of the thematic constituents within a sentence is termed the canonical or standard ordering of the constituents in the English language. In contrast, passive sentences are composed with the object of the sentence appearing first, followed by the verb, then finally by the subject (O-V-S). The object-verb-subject (O-V-S) ordering is termed the non-canonical ordering of constituents in the English language. Typically, sentences with non-canonical ordering (passive sentences) are more difficult to comprehend than that of the sentences with the canonical ordering (active sentences).

Stimuli Development and Presentation

Auditory stimuli for single nouns for verbal-visual tasks will be taken from the list developed in Example 1. Briefly, additional auditory stimuli for the auditory-only tasks were developed in substantially the same way as that of Example 1. Tokens were recorded by an adult male native speaker of American English in a sound-treated booth using a microphone connected to a PC. The speaker recorded each token multiple times. The token with the highest quality of articulation and word-level stress were chosen by three listeners in 100% agreement. Each token was digitized (22 kHz, low-pass filtered at 10.5 kHz), normalized for intensity to zero dB, and stored on the computer using Adobe Audition 2.0® (2006). Auditory stimuli for active and passive sentences will be recorded, selected, digitized, normalized, and stored using the process described above and in Example 1 for single nouns.

Visual stimuli for single nouns will use the stimuli developed in Example 1. Briefly, color images from Rossion and Pourtoise (2004) were selected to match chosen nouns. The visual stimuli for sentences will be developed in substantially the same as that of Example 1 for single nouns. However, the images for sentences will be selected from EPTAC and VAST, and they are black-and-white line drawings, no manipulation in terms of color or shading will be required for the visual stimuli for active and passive sentences. Such images will be manipulated only to the extent necessary to prevent distortion when displayed by the pupillary response software, and to maintain similar luminance across items.

### Procedure

Auditory-only and auditory-visual experimental condition will be counterbalanced between participants. Counterbalancing means that the two conditions were assigned randomly to participants for equal representation between two sub-groups. Items within these conditions will also be counterbalanced; no participant will hear the same sentence in both the auditory-visual and the auditory-only condition. Breaks will be offered between tasks as needed.

Participants will be seated 24-26 inches from the computer screen. Following the pupillary response tasks, participants will be administered the following subtests of the Psycholinguistic Assessment of Language Processing in Aphasia (PALPA; Kay, Lesser, & Coltheart, 1992): subtest 44—Spoken Word-Picture Matching, and subtest 55—Sentence-Picture Matching, Auditory Version, which will be used to validate intact comprehension and correlate with pupillary results.

Baseline Test

A baseline measurement of participants' pupil diameter will be obtained to allow computation of TERPs via the subtraction method. The baseline test will be conducted in the following manner: In between each image in the auditory-visual condition, and presentation of each auditory stimulus in the auditory-only condition, a fixation point will be displayed for three seconds. During the last 500 milliseconds of this period (to allow for any changes in the pupil in reaction to the change of stimuli on the screen), measurements of the participants' pupil diameter will be collected and averaged. This value will serve as the baseline value or measurement for each condition, and will be used during the subtraction method to obtain mean and maximum TERPs.

Auditory-Visual Method

During the auditory-visual task (a version of verbal-visual task), visual and auditory stimuli will be presented simultaneously. Auditory stimuli will be presented via headphones at approximately 65 dB, as determined by a sound level meter. Participants will be instructed to “Listen to the words and sentences and look at the images in any way that comes naturally to you.” Images will be displayed for three seconds following the offset of the verbal stimulus. This time frame for single nouns was used in Example 1, and it is believed that this time frame allows for ample time to observe TERPs. As TERPs typically occur within 100-200 msec following the onset of processing and subside quickly following the termination of processing (Beatty, 1982), TERPs of interest may occur while the auditory stimulus is playing for sentences. Still, visual stimulus items will be kept on the screen for three seconds following the offset of each verbal stimulus in order to allow ample time for participants to process sentences.

The majority of auditory and visual stimulus items will match during this condition or task (see FIG. 5). For example, if the auditory stimulus is “banana”, a picture of a banana will be presented. However, 20% of trials will consist of foil stimuli, in which the auditory and visual stimulus items do not match (see FIG. 6). These foil stimuli trials will be inserted to prevent participants from expecting identical auditory and visual stimulus items. This unexpected element will help to prevent boredom and maintain participant attention throughout the experiment.

Auditory-Only Task

In the auditory-only task (see FIGS. 1 and 1a), auditory stimuli will be presented via headphones at 65 dB. Participants will be instructed to stare at a fixation point on the computer screen, which will be similar in luminance to items presented during the auditory-visual task and the baseline task. This will be done to allow for comparison between auditory-visual and auditory-only tasks. Participants will be instructed to “Listen to the words and sentences while you look at the dot on the screen. You will be asked some questions during the task, so be sure to listen carefully.” In order to keep the time frame consistent between the auditory-visual and auditory-only tasks, there will be a three-second time window between the offset of one auditory stimulus and the onset of the next.

Off-Line Test of Comprehension (Post-Task Comprehension Test).

Following the assessment tasks, participants will be administered the spoken word-picture matching and sentence-picture matching subtests of the PALPA (Kay, Lesser, & Colt heart, 1992). The PALPA is a widely used test of language abilities in individuals with aphasia. It is also ideal in that control participants do not always score at ceiling levels. The results from the PALPA will be used to determine the level at which participants comprehend single nouns and sentences similar to those used during the pupillary assessment portion of the experiment. These results will be correlated with the results obtained from pupillometric measures.

Analysis of Pupillary Response Data (Dependent Measures)

TERPs will be calculated in three different ways in order to compare significant results across computation methods: absolute values, subtracted values, and normalized values. Dependent measures (pupillary response data) will consist of mean pupil diameter, maximum pupil diameter, and latency to maximum pupil diameter for the absolute value and subtraction methods, as described in Example 1, and normalized pupil data for the normalization method. Custom software will be used to extract and analyze data related to dependent measures.

For absolute values, mean and maximum TERPs will be reported as millimeters of pupil diameters, rather than a change in dilation. In the subtraction method, the average pupil diameter obtained during the baseline task will be subtracted from mean and maximum TERPs in order to obtain the amount of change, in millimeters, induced by the experimental tasks. Latency of maximum pupil diameter for both methods will be reported in milliseconds between the initiation of each trial and the single maximum pupil diameter obtained within each trial.

The normalization method will be similar to the one detailed by Engelhardt and colleagues (2009) and Gutierrez and Shapiro (2011). Mean pupil diameter will be obtained for each participant in each condition (i.e., easy nouns, difficult nouns, easy sentences, difficult sentences). Each pupillary data point in the analysis time-frame (verbal stimulus item plus three seconds) will then be divided by the mean pupil diameter for that condition. The normalized data will then be averaged at each time point over all participants to obtain a waveform of pupil dilation in each condition. Normalized data will also be submitted into a simple regression analysis with time as the independent variable and normalized pupil data as the dependent variable in order to obtain the slope of pupillary change for each condition.

### Hypothesis

1. Participants will exhibit differences in pupillary responses corresponding to easy and difficult stimulus items.
a. Participants will exhibit differences in absolute pupil diameter (measured in mm) corresponding to easy and difficult stimuli.
b. Participants will exhibit differences in TERPs (i.e., mean (measured in mm), maximum (measured in mm), and latency to maximum (measured in msec)) corresponding to easy and difficulty stimuli.
c. Participants will exhibit differences in normalized pupillary responses (i.e., normalized pupillary waveform and slope of pupillary change) corresponding to easy and difficult stimuli.

2. Participants will exhibit differences in pupillary responses corresponding to stimuli presented in the auditory-visual condition and stimuli presented in the auditory-only condition.
a. Participants will exhibit differences in absolute pupil diameter (measured in mm) corresponding to stimuli presented in the auditory-visual condition and stimuli presented in the auditory-only condition.
b. Participants will exhibit differences in TERPs (i.e., mean (measured in mm), maximum (measured in mm), and latency to maximum (measured in msec)) corresponding to stimuli presented in the auditory-visual condition and stimuli presented in the auditory-only condition.
c. Participants will exhibit differences in normalized pupillary responses (i.e., normalized pupillary waveform and slope of pupillary change) corresponding to stimuli presented in the auditory-visual condition and stimuli presented in the auditory-only condition.

3. Significant and/or non-significant results obtained will not differ based on method of computation of TERPs.
a. If significant differences are obtained for any manipulated variable using one computation method (i.e., subtraction method), these differences will also be found using the other computational methods (absolute value, normalization).

### Analysis

Hypotheses #1 and Hypothesis #2 will be statistically analyzed using a repeated-measures analysis of variance. Any significant main effects will be analyzed using dependent-measures t-tests of means. Analyses will be performed separately for each calculation method (i.e., three different repeated-measures analysis of variance will be conducted, one for the absolute value method, one for the subtraction method, and one for the normalization method).

To test Hypothesis #3, significant and/or non-significant results obtained from each analysis will be compared and contrasted by the experimenter.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method for assessing a patient's linguistic comprehension using a pupil response system comprising at least one pupillometer configured to measure the patient's pupil responses, comprising:
a. providing the patient with a list of verbal stimuli comprising at least two sets of verbal stimuli, each set of verbal stimuli comprising one or more verbal stimuli; wherein the at least two sets of the verbal stimuli differ substantially from each other in difficulty level;
b. presenting to the patient one verbal stimulus at a time from the list of verbal stimuli;
c. measuring and recording the patient's pupil response data for a period of time ranging from about 200 milliseconds to about 10 seconds during the presentation of each stimulus; and
d. analyzing the pupil response data to assess the patient's linguistic comprehension.

2. The method in accordance with claim 1, wherein the patient is neurologically impaired.

3. The method in accordance with claim 2, further comprising administering an impairment severity test prior to presenting the patient with stimuli.

4. The method in accordance with claim 1, further comprising a step of administering a baseline test to the patient, and measuring and/or recording the patient's pupillary response data during the baseline test.

5. The method in accordance with claim 1, wherein the verbal stimulus is presented audibly.

6. The method in accordance with claim 1, wherein the verbal stimulus is presented textually.

7. The method in accordance with claim 1, wherein the verbal stimulus comprises one or more words, one or more sentences, or a mixture thereof.

8. The method in accordance with claim 1, wherein the verbal stimulus comprises one or more words; and the difficulty level of the word is based on one or more difficulty criteria comprising age of acquisition, word frequency, familiarity, naming latency, other similar factors, or combinations or mixtures thereof.

9. The method in accordance with claim 1, wherein the verbal stimulus comprises one or more sentences, and the difficulty level of the sentence is determined according to one or more criteria comprising sentence length, sentence branches, number of verbs, number of imbedded clauses, other similar factors, or combinations or mixtures thereof.

10. The method in accordance with claim 1, wherein the pupil responses include pupil diameter, maximum pupil diameter, time to maximum pupil diameter, average pupil diameter, and other similar data.

11. The method in accordance with claim 1, further comprising a step of instructing the patient to look at a fixation point during the presentation of each of the verbal stimulus.

12. The method in accordance with claim 1, further comprising a step of administering to the patients one or more comprehension tests in between the presentation of verbal stimuli to keep the patient focused on the assessment test.

13. The method in accordance with claim 1, further comprising a step of presenting the patient with a visual stimulus at the same time as or immediately after presenting each of the verbal stimulus, the visual stimulus comprising at least one image that corresponds to the verbal stimulus being presented at the same time or immediately prior to the visual stimulus.

14. The method in accordance with claim 13, further comprising administering to the patient a foil stimulus trial to keep the patient focus on the assessment process, comprising the steps of
a) presenting the patient with a foil stimulus at the same time as or immediately after presenting a verbal stimulus, the foil stimulus comprising one or more images that do not correspond to the verbal stimulus being presented at the same time or immediately prior to the foil stimulus; and
b) repeating step a at one or more intervals.

15. The method in accordance with claim 13, further comprising presenting the patient with a filler stimulus comprising dots or similar items in order to substantially reduce or prevent the pupillary changes in the patient due to any potential abrupt change in luminance between the stimuli.

16. The method in accordance with claim 13, wherein the visual stimulus is presented on a computer monitor screen.

17. The method in accordance with claim 13, further comprising designing the visual stimulus to minimize the presence of distracting visual features.

18. The method in accordance with claim 1, wherein the pupil response system comprises a video camera.

19. A method according to claim 18, wherein the pupil response system further comprises a near infrared light.

20. The method in accordance with claim 1, wherein the pupil response system further comprises processing software to identify, measure, record, and analyze the patient's pupil center, pupil diameter, or other related pupillary response data.

21. The method in accordance with claim 1, further comprising administering a hearing screening prior to presenting the patient with stimuli.

22. The method in accordance with claim 1, further comprising administering a vision screening prior to presenting the patient with stimuli.

23. The method in accordance with claim 1, further comprising evaluating the perceived difficulty of the verbal stimuli by asking the patient to sort the verbal stimuli into two different levels: one relatively easy, the other relatively difficult.
